(19) United States
(12) Patent Application Publication
(10) Pub. No.: US 2026/0311009 A1
(43) Pub. Date: Oct. 8, 2026

(54) SYSTEMS AND METHODS FOR REAL-TIME ASSESSMENT AND PERFORMANCE OPTIMIZATION OF COMPUTE INFRASTRUCTURE

(71) Applicant: Penguin Computing, Inc., Fremont, CA (US)

(72) Inventors: Kevin Manalo, Saint Johns, FL (US); Nicholas McCollum, Decatur, AL (US); Mark Seamans, San Diego, CA (US); Sharri Parsell, Portland, OR (US)

(73) Assignee: Penguin Computing, Inc., Fremont, CA (US)

(21) Appl. No.: 19/568,323

(22) Filed: Mar. 16, 2026

Related U.S. Application Data
(60) Provisional application No. 63/782,317, filed on Apr. 2, 2025.

(51) Int. Cl. G06N 5/045

(52) U.S. Cl. CPC G06N 5/045

(57) ABSTRACT

A system and method includes obtaining compute infrastructure data associated with an AI compute system, computing, using the compute infrastructure data, a maximum compute performance obtainable by the AI compute system, executing one or more compute performance tests on the AI compute system to determine a current compute performance of the AI compute system, executing an automated node health assessment that determines a total number of AI compute nodes online in the AI compute system and a total number of AI compute nodes included in the AI compute system, and computing a percent of potential value for the AI compute system based on the total number of AI compute nodes online in the AI compute system, the total number of AI compute nodes included in the AI compute system, the current compute performance of the AI compute system, and the maximum compute performance obtainable by the AI compute system.

### CROSS-REFERENCE TO RELATED APPLICATIONS

This application claims the benefit of U.S. Provisional Application No. 63/782,317, filed 2 Apr. 2025, which is incorporated in its entirety by this reference.

### TECHNICAL FIELD

This invention relates generally to the computer management field, and more specifically, to new and useful systems and methods for real-time assessment, scoring, and performance optimization of compute infrastructure in the computer management field.

### BACKGROUND

Traditionally, assessing high-performance compute infrastructure is a time-consuming process that requires a high level of specialized knowledge in high-performance computing development and design. This time-consuming process fails to scale effectively to meet the growing computational demands of modern artificial intelligence (AI) applications and AI workloads. Furthermore, this process lacks explainability, making it difficult for subscribers to understand how compute bottlenecks, compute performance issues, compute inefficiencies, and/or the like within their current compute configuration impacts performance.

Therefore, there is a need in the art to accelerate the assessment and optimization of high-performance compute infrastructure, while also providing greater explainability to help subscribers understand the impact of the compute bottlenecks and compute performance issues within their current compute configuration and how to reduce or eliminate such compute bottlenecks and/or compute performance issues to increase compute performance. The embodiments of the present application provide technical solutions that address, at least, the needs described above, as well as the deficiencies in the state of the art.

### BRIEF SUMMARY OF THE EMBODIMENTS

In one embodiment, a computer-implemented method for real-time generation and performance optimization of high-performance computing (HPC) architectures includes at a compute architecture optimization service implemented by a distributed network of computers: obtaining, via a graphical user interface, a set of compute architecture design parameters associated with a target subscriber, wherein the set of compute architecture design parameters include: one or more distinct types of artificial intelligence (AI) compute tasks the target subscriber intends to execute within a HPC environment, and a set of compute architecture design constraints specifying one or more immutable boundaries for controlling a compute architecture design space used by the compute architecture optimization service; generating, by the distributed network of computers, a HPC architecture data object for the target subscriber that satisfies the set of compute architecture design parameters obtained via the graphical user interface, wherein generating the HPC architecture data object includes: translating the set of compute architecture design parameters into a set of hardware components and a set of software components that are (i) collectively capable of supporting execution of the one or more distinct types of AI compute tasks and (ii) reside within the compute architecture design space formed according to the set of compute architecture design constraints, and in response to generating the HPC architecture data object for the target subscriber: executing, in real-time or near real-time by the distributed network of computers, one or more automated pairwise assessments between the HPC architecture data object generated for the target subscriber and a reference HPC architecture data object; computing, in real-time or near real-time by the distributed network of computers, a percent of potential score that indicates a degree of performance disparity between the HPC architecture data object generated for the target subscriber and the reference HPC architecture data object based on pairwise assessment findings outputted by the one or more automated pairwise assessments; and constructing, in the real-world, an optimal HPC environment for the target subscriber that corresponds to the HPC architecture data object when the percent of potential score satisfies a predetermined minimum score threshold value.

In one embodiment, at least one of the one or more automated pairwise assessments detects that a first compute architecture deviation exists between the HPC architecture data object generated for the target subscriber and the reference HPC architecture data object, the computer-implemented method further includes automatically retrieving, using the distributed network of computers, a performance degradation factor that corresponds to the first compute architecture deviation in response to querying a performance degradation repository using the first compute architecture deviation as a query parameter, and the percent of potential score is computed by deducting the performance degradation factor that corresponds to the first compute architecture deviation from a service-default percent of potential score attributed to the reference HPC architecture data object.

In one embodiment, the one or more automated pairwise assessments detect that a plurality of compute architecture deviations exist between the HPC architecture data object generated for the target subscriber and the reference HPC architecture data object, the computer-implemented method further includes automatically retrieving, using the distributed network of computers, a respective performance degradation factor that corresponds to each compute architecture deviation of the plurality of compute architecture deviations in response to querying a performance degradation repository using the plurality of compute architecture deviations as query parameters, and the percent of potential score is computed for the HPC architecture data object by deducting the respective performance degradation factor that corresponds to each compute architecture deviation of the plurality of compute architecture deviations from a service-default percent of potential score attributed to the reference HPC architecture data object.

In one embodiment, the computer-implemented method further includes displaying, via the graphical user interface, a plurality of selectable normalization factors, wherein each selectable normalization factor of the plurality of selectable normalization factors corresponds to a distinct performance criterion for assessing the HPC architecture data object generated for the target subscriber relative to the reference HPC architecture data object; receiving, via the graphical user interface, a user input selecting a selectable bandwidth normalization factor of the plurality of selectable normalization factors; and in response to receiving the user input selecting the selectable bandwidth normalization factor displayed on the graphical user interface, automatically computing an additional percent of potential score for the HPC architecture data object generated for the target subscriber based on assessing a maximum bandwidth capacity of the HPC architecture data object against a maximum bandwidth capacity of the reference HPC architecture data object.

In one embodiment, the computer-implemented method further includes displaying, via the graphical user interface, a plurality of selectable normalization factors, wherein each selectable normalization factor of the plurality of selectable normalization factors corresponds to a distinct architecture performance assessment criterion; detecting, via the graphical user interface, a sequence of one or more user inputs selecting each of the plurality of selectable normalization factors displayed on the graphical user interface; and in response to detecting the sequence of the one or more user inputs, simultaneously computing, in parallel, a respective normalized percent of potential score for each of the plurality of selectable normalization factors selected using the graphical user interface, wherein each respective normalized percent of potential score is computed based on the distinct architecture performance assessment criterion of a respective selectable normalization factor of the plurality of selectable normalization factors for which that respective normalized percent of potential score corresponds.

In one embodiment, the percent of potential score computed for the HPC architecture data object does not satisfy the predetermined minimum score threshold value, the computer-implemented method further includes in response to detecting the percent of potential score computed for the HPC architecture data object does not satisfy the predetermined minimum score threshold value: providing the HPC architecture data object generated for the target subscriber and the reference HPC architecture data object as input to a machine learning model; predicting, using the machine learning model, one or more percent of potential improvement recommendations for the HPC architecture data object based on the machine learning model assessing the HPC architecture data object generated for the target subscriber and the reference HPC architecture data object; adapting the HPC architecture data object generated for the target subscriber to an adapted HPC architecture data object based on the one or more percent of potential improvement recommendations predicted by the machine learning model; computing, in real-time or near real-time by the distributed network of computers, a second percent of potential score for the adapted HPC architecture data object indicating a degree of performance disparity between the adapted HPC architecture data object and the reference HPC architecture data object, wherein the second percent of potential score computed for the adapted HPC architecture data object satisfies the predetermined minimum score threshold value; and constructing, in the real-world, an optimal HPC environment for the target subscriber corresponding to the adapted HPC architecture data object based on the second percent of potential score satisfying the predetermined minimum score threshold value.

In one embodiment, the one or more percent of potential improvement recommendations include a first percent of potential improvement recommendation that textually indicates replacing an ethernet-based networking configuration specified by the HPC architecture data object with an InfiniBand-based networking configuration, a second percent of potential improvement recommendation that textually indicates updating a firmware version associated with one or more hardware components specified by the HPC architecture data object to a current firmware version or at least a more recent firmware version than the firmware version currently specified by the HPC architecture data object, a third percent of potential improvement recommendation that textually indicates increasing a total number of compute nodes specified by the HPC architecture data object to a greater quantity of compute nodes than currently specified by the HPC architecture data object, and a fourth percent of potential improvement recommendation that textually indicates replacing a first type of graphics processing unit (GPU) specified by the HPC architecture data object with a different GPU type.

In one embodiment, the HPC architecture data object generated for the target subscriber includes a structured representation of a subscriber-specific compute architecture, the reference HPC architecture data object includes a structured representation of a reference compute architecture, and the computer-implemented method further includes: displaying, via the graphical user interface, a graphical representation of the subscriber-specific compute architecture; displaying, via the graphical user interface, a graphical representation of the reference compute architecture; and displaying, via the graphical user interface, the percent of potential score between the graphical representation of the subscriber-specific compute architecture and the graphical representation of the reference compute architecture, wherein the graphical representation of the subscriber-specific compute architecture is spatially separated from the graphical representation of the reference compute architecture.

In one embodiment, executing the one or more automated pairwise assessments include: assessing a maximum bandwidth capacity of the HPC architecture data object against a maximum bandwidth capacity of the reference HPC architecture data object, assessing a total number of computing nodes included in the HPC architecture data object against a total number of computing nodes included in the reference HPC architecture data object, assessing a backend networking infrastructure of the HPC architecture data object against a backend networking infrastructure of the reference HPC architecture data object, assessing a type of graphics processing units included in the HPC architecture data object against a type of graphics processing units included in the reference HPC architecture data object, and assessing a network latency profile of the HPC architecture data object against a network latency profile of the reference HPC architecture data object.

In one embodiment, generating the HPC architecture data object for the target subscriber further includes instantiating, by the distributed network of computers, a data model based on a compute architecture schema provided by the compute architecture optimization service in response to translating the set of compute architecture design parameters into the set of hardware components and the set of software components, and encoding, by the distributed network of computers, the data model to include the set of hardware components and the set of software components.

In one embodiment, the percent of potential score satisfies the predetermined minimum score threshold value, and constructing the optimal HPC environment for the target subscriber includes: physically installing a plurality of computing nodes specified by the HPC architecture data object at a target real-world location or a target physical location, wherein each computing node of the plurality of computing nodes includes a plurality of graphics processing units (GPUs) and a plurality of central processing units (CPUs), and physically connecting the plurality of computing nodes together using a plurality of physical networking components as specified by the HPC architecture data object.

In one embodiment, the computer-implemented method further includes before computing the percent of potential score that indicates the degree of performance disparity between the HPC architecture data object generated for the target subscriber and the reference HPC architecture data object: computing a plurality of normalized percent of potential scores that collectively assess the HPC architecture data object and the reference HPC architecture data object across multiple distinct performance dimensions, and computing a composite percent of potential score based on a combination of the plurality of normalized percent of potential scores, wherein the composite percent of potential score is used as the percent of potential score that indicates the degree of performance disparity between the HPC architecture data object and the reference HPC architecture data object.

In one embodiment, the compute architecture optimization service includes a plurality of predetermined reference HPC architecture data objects, the computer-implemented method further includes before executing the one or more automated pairwise assessments: detecting, via the graphical user interface, an input from a user selecting a target one of the plurality of predetermined reference HPC architecture data objects that corresponds to the reference HPC architecture data object, and in response to detecting the input from the user selecting the target one of the plurality of predetermined reference HPC architecture data objects, automatically commencing the one or more automated pairwise assessments.

In one embodiment, the compute architecture optimization service automatically elects the reference HPC architecture data object to be assessed against the HPC architecture data object, and in response to the compute architecture optimization service automatically electing the reference HPC architecture data object, automatically commencing the one or more automated pairwise assessments.

In one embodiment, a computer-program product comprising a non-transitory machine-readable storage medium storing computer instructions that, when executed by one or more processors, perform operations including at a compute architecture optimization service: obtaining, via a graphical user interface, a set of compute architecture design parameters associated with a target subscriber, wherein the set of compute architecture design parameters include: one or more distinct types of artificial intelligence (AI) compute tasks the target subscriber intends to execute within a HPC environment, and a set of compute architecture design constraints specifying one or more immutable boundaries for controlling a compute architecture design space used by the compute architecture optimization service; generating, by the one or more processors, a HPC architecture data object for the target subscriber that satisfies the set of compute architecture design parameters obtained via the graphical user interface, wherein generating the HPC architecture data object includes: translating the set of compute architecture design parameters into a set of hardware components and a set of software components that are (i) collectively capable of supporting execution of the one or more distinct types of AI compute tasks and (ii) reside within the compute architecture design space formed according to the set of compute architecture design constraints, and in response to generating the HPC architecture data object for the target subscriber: executing, in real-time or near real-time by the one or more processors, one or more automated pairwise assessments between the HPC architecture data object generated for the target subscriber and a reference HPC architecture data object; computing, in real-time or near real-time by the one or more processors, a percent of potential score that indicates a degree of performance disparity between the HPC architecture data object generated for the target subscriber and the reference HPC architecture data object based on pairwise assessment findings outputted by the one or more automated pairwise assessments; and constructing, in the real-world, an optimal HPC environment corresponding to the HPC architecture data object when the percent of potential score satisfies a predetermined minimum score threshold value.

In one embodiment, the computer instructions, when executed by the one or more processors, perform operations further comprising automatically generating a plurality of percent of potential score improvement recommendations for the HPC architecture data object, wherein each percent of potential score improvement recommendation of the plurality of percent of potential score improvement recommendations includes a proposed modification to one or more hardware components or software components specified by the HPC architecture data object; displaying, via the graphical user interface, the plurality of percent of potential score improvement recommendations in association with a graphical representation of the HPC architecture data object generated for the target subscriber and a graphical representation of the reference HPC architecture data object, detecting an input selecting one of the plurality of percent of potential score improvement recommendations, and in response to detecting the input selecting the one of the plurality of percent of potential score improvement recommendations, automatically adapting the graphical representation of the HPC architecture data object displayed on the graphical user interface to include the proposed modification that corresponds to the one of the plurality of percent of potential score improvement recommendations.

In one embodiment, the computer instructions, when executed by the one or more processors, perform operations further comprising automatically generating a plurality of percent of potential score improvement recommendations for the HPC architecture data object, wherein each percent of potential score improvement recommendation of the plurality of percent of potential score improvement recommendations includes a proposed modification to one or more hardware components or software components specified by the HPC architecture data object; displaying, via the graphical user interface, the plurality of percent of potential score improvement recommendations in association with a graphical representation of the HPC architecture data object generated for the target subscriber and a graphical representation of the reference HPC architecture data object, detecting an input selecting one of the plurality of percent of potential score improvement recommendations, and in response to detecting the input selecting the one of the plurality of percent of potential score improvement recommendations: automatically scrolling or automatically navigating within the graphical representation of the HPC architecture data object to a portion of the graphical representation of the HPC architecture data object that corresponds to the proposed modification specified by the one of the plurality of percent of potential score improvement recommendations.

In one embodiment, the computer instructions, when executed by the one or more processors, perform operations further comprising: detecting, during the execution of the one or more automated pairwise assessments, a plurality of compute architecture deviations between the HPC architecture data object generated for the target subscriber and the reference HPC architecture data object; attributing a corresponding performance degradation factor to each compute architecture deviation of the plurality of compute architecture deviations; and displaying, via the graphical user interface, a data table that includes the plurality of compute architecture deviations in association with their respective corresponding performance degradation factor.

In one embodiment, the computer instructions, when executed by the one or more processors, perform operations further comprising: displaying, via the graphical user interface, a graphical representation of the HPC architecture data object; automatically generating, for each compute architecture deviation of the plurality of compute architecture deviations, a corresponding graphical marker within the graphical representation of the HPC architecture data object; detecting a user input selecting the corresponding graphical marker associated with a first compute architecture deviation of the plurality of compute architecture deviations, wherein a user interface position of the corresponding graphical marker associated with the first compute architecture deviation within the graphical representation of the HPC architecture data object corresponds to a location of a hardware or software component of the HPC architecture data object contributing to the first compute architecture deviation; and in response to detecting the user input selecting the corresponding graphical marker associated with the first compute architecture deviation, instantiating, via the graphical user interface, a popover user interface object that includes a natural language description of the first compute architecture deviation, the corresponding performance degradation factor attributed to the first compute architecture deviation, and one or more recommended compute architectural modifications to resolve the first compute architecture deviation.

In one embodiment, a computer-implemented system including: one or more processors; a memory; a computer-readable medium operably coupled to the one or more processors, the computer-readable medium having computer-readable instructions stored thereon that, when executed by the one or more processors, cause a computing device to perform operations comprising: at a compute architecture optimization service: obtaining, via a graphical user interface, a set of compute architecture design parameters associated with a target subscriber, wherein the set of compute architecture design parameters include: one or more distinct types of artificial intelligence (AI) compute tasks the target subscriber intends to execute within a HPC environment, and a set of compute architecture design constraints specifying one or more immutable boundaries for controlling a compute architecture design space used by the compute architecture optimization service; generating, by the one or more processors, a HPC architecture data object for the target subscriber that satisfies the set of compute architecture design parameters obtained via the graphical user interface, wherein generating the HPC architecture data object includes: translating the set of compute architecture design parameters into a set of hardware components and a set of software components that are (i) collectively capable of supporting execution of the one or more distinct types of AI compute tasks and (ii) reside within the compute architecture design space formed according to the set of compute architecture design constraints, and in response to generating the HPC architecture data object for the target subscriber: executing, in real-time or near real-time by the one or more processors, one or more automated pairwise assessments between the HPC architecture data object generated for the target subscriber and a reference HPC architecture data object; computing, in real-time or near real-time by the one or more processors, a percent of potential score for the HPC architecture data object that indicates a degree of performance disparity between the HPC architecture data object generated for the target subscriber and the reference HPC architecture data object based on pairwise assessment findings outputted by the one or more automated pairwise assessments; and constructing, in the physical world, an optimal HPC environment corresponding to the HPC architecture data object when the percent of potential score satisfies a predetermined minimum score threshold value.

In one embodiment, a computer-implemented method for real-time generation and performance optimization of high-performance computing (HPC) architectures includes at a compute architecture optimization service implemented by a distributed network of computers: obtaining, via a graphical user interface, a set of compute architecture design parameters associated with a target subscriber, wherein the set of compute architecture design parameters include: one or more distinct types of artificial intelligence (AI) compute tasks the target subscriber intends to execute within a HPC environment, and a set of compute architecture design constraints specifying one or more immutable boundaries for controlling a compute architecture design space used by the compute architecture optimization service; generating, by the distributed network of computers, a HPC architecture data object for the target subscriber that satisfies the set of compute architecture design parameters obtained via the graphical user interface, wherein generating the HPC architecture data object includes: translating the set of compute architecture design parameters into a set of hardware components and a set of software components that are (i) collectively capable of supporting execution of the one or more distinct types of AI compute tasks and (ii) reside within the compute architecture design space formed according to the set of compute architecture design constraints, and in response to generating the HPC architecture data object for the target subscriber: executing, in real-time or near real-time by the distributed network of computers, one or more automated pairwise assessments between the HPC architecture data object generated for the target subscriber and a reference HPC architecture data object; computing, in real-time or near real-time by the distributed network of computers, a percent of potential value that indicates a likely degree of computing performance disparity between the HPC architecture data object generated for the target subscriber and the reference HPC architecture data object based on pairwise assessment findings outputted by the one or more automated pairwise assessments; and constructing, in the real-world, an optimal HPC environment for the target subscriber that: improves a likely computing performance, when executing the one or more distinct types of AI compute tasks, by implementing the optimal HPC environment in lieu of a non-optimized HPC environment of a non-optimized HPC architecture data object, and homologously corresponds to the HPC architecture data object when the percent of potential value satisfies a predetermined minimum score threshold value. It shall be recognized that in some embodiments, an HPC architecture data object may be a non-optimized HPC architecture data object when a respective percent of potential value computed for the HPC architecture data object does not satisfy the predetermined minimum score threshold value. In other words, in some embodiments, a HPC architecture data object having an associated percent of potential value below the predetermined minimum score threshold value may be determined to be a non-optimized HPC architecture data object.

In one embodiment, the percent of potential value computed for the HPC architecture data object does not satisfy the predetermined minimum score threshold value, the computer-implemented method further includes: in response to detecting the percent of potential value computed for the HPC architecture data object does not satisfy the predetermined minimum score threshold value: providing the HPC architecture data object generated for the target subscriber and the reference HPC architecture data object as input to a machine learning model; predicting, using the machine learning model, one or more percent of potential improvement recommendations for the HPC architecture data object based on the machine learning model assessing the HPC architecture data object generated for the target subscriber and the reference HPC architecture data object; adapting the HPC architecture data object generated for the target subscriber to an adapted HPC architecture data object based on the one or more percent of potential improvement recommendations predicted by the machine learning model; computing, in real-time or near real-time by the distributed network of computers, a second percent of potential value for the adapted HPC architecture data object indicating a degree of performance disparity between the adapted HPC architecture data object and the reference HPC architecture data object, wherein the second percent of potential value computed for the adapted HPC architecture data object satisfies the predetermined minimum score threshold value; and constructing, in the real-world, an optimal HPC environment for the target subscriber corresponding to the adapted HPC architecture data object based on the second percent of potential value satisfying the predetermined minimum score threshold value, wherein the optimal HPC environment for the target subscriber corresponding to the adapted HPC architecture data is constructed in lieu of a compute environment homologously corresponding to the HPC architecture data object generated for the target subscriber.

In one embodiment, the percent of potential value computed for the HPC architecture data object does not satisfy the predetermined minimum score threshold value, the computer-implemented method further includes: in response to detecting the percent of potential value computed for the HPC architecture data object does not satisfy the predetermined minimum score threshold value: providing the HPC architecture data object generated for the target subscriber and the reference HPC architecture data object as input to a machine learning model; predicting, using the machine learning model, one or more percent of potential improvement recommendations for the HPC architecture data object based on the machine learning model assessing the HPC architecture data object generated for the target subscriber and the reference HPC architecture data object; adapting the HPC architecture data object generated for the target subscriber to an adapted HPC architecture data object based on the one or more percent of potential improvement recommendations predicted by the machine learning model; computing, in real-time or near real-time by the distributed network of computers, a second percent of potential value for the adapted HPC architecture data object indicating a degree of computing performance disparity between the adapted HPC architecture data object and the reference HPC architecture data object, wherein the second percent of potential value computed for the adapted HPC architecture data object satisfies the predetermined minimum score threshold value; and constructing, in the real-world, an optimal HPC environment corresponding to the adapted HPC architecture data object for the target subscriber based on the second percent of potential value satisfying the predetermined minimum score threshold value, wherein the optimal HPC environment corresponding to the adapted HPC architecture data is constructed in lieu of a compute environment homologously corresponding to the HPC architecture data object generated for the target subscriber.

In one embodiment, a computer-implemented method for real-time assessment and performance optimization of artificial intelligence (AI) compute infrastructure includes receiving, via a computer network, a request to assess compute performance of an AI compute system that executes AI workloads for a subscribing entity; obtaining, in response to receiving the request, compute infrastructure data associated with the AI compute system, wherein the compute infrastructure data includes at least: a corpus of compute node identifiers that includes a respective compute node identifier for each AI compute node of the AI compute system; in response to obtaining the compute infrastructure data associated with the AI compute system: automatically computing, using the compute infrastructure data, a maximum compute performance obtainable by the AI compute system; automatically executing, using one or more processors, one or more compute performance tests on the AI compute system to determine a current compute performance of the AI compute system; and automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system; automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein: the percent of potential value computed for the AI compute system indicates a degree to which the AI compute system is operating below the maximum compute performance obtainable by the AI compute system; and generating, in response to computing the percent of potential value, one or more explainability artifacts that graphically identify one or more AI compute nodes or one or more pods within the AI compute system that cause the AI compute system to operate below the maximum compute performance; and displaying, via a graphical user interface, the percent of potential value computed for the AI compute system in association with the one or more explainability artifacts.

In one embodiment, computing the percent of potential value for the AI compute system includes: computing an AI node availability value of the AI compute system based on a ratio between the total number of AI compute nodes online in the AI compute system and the total number of AI compute nodes included in the AI compute system, computing a compute utilization value of the AI compute system based on a ratio between the current compute performance of the AI compute system and the maximum compute performance obtainable by the AI compute system, and computing the percent of potential value for the AI compute system based on a product of the AI node availability value and the compute utilization value.

In one embodiment, the maximum compute performance obtainable by the AI compute system includes a maximum bandwidth capacity obtainable by the AI compute system, the current compute performance of the AI compute system includes a current bandwidth capacity of the AI compute system, and wherein computing the percent of potential value for the AI compute system includes: computing an AI node availability value of the AI compute system based on a ratio between the total number of AI compute nodes online in the AI compute system and the total number of AI compute nodes included in the AI compute system, computing a bandwidth efficacy value of the AI compute system based on a ratio between the current bandwidth capacity of the AI compute system and the maximum bandwidth capacity obtainable by the AI compute system, and computing the percent of potential value for the AI compute system based on a product of the AI node availability value and the bandwidth efficacy value.

In one embodiment, the maximum compute performance obtainable by the AI compute system includes a maximum parallel floating-point operations per second (FLOPS) value expected by the AI compute system, the current compute performance of the AI compute system includes a current parallel FLOPS value measured for the AI compute system, and wherein computing the percent of potential value for the AI compute system includes: computing an AI node availability value of the AI compute system based on a ratio between the total number of AI compute nodes online in the AI compute system and the total number of AI compute nodes included in the AI compute system, computing a FLOPS efficacy value of the AI compute system based on a ratio between the current parallel FLOPS value measured for the AI compute system and the maximum FLOPS value expected by the AI compute system, and computing the percent of potential value for the AI compute system based on a product of the AI node availability value and the FLOPS efficacy value.

In one embodiment, the computer-implemented method further includes in response to generating the one or more explainability artifacts: providing the compute infrastructure data and a representation of the one or more explainability artifacts as input to a machine learning model; generating, using the machine learning model, one or more percent of potential improvement recommendations based on the machine learning model assessing the compute infrastructure data and the representation of the one or more explainability artifacts, wherein: each percent of potential improvement recommendation specifies a distinct corrective action to mitigate a compute performance issue affecting at least one of the one or more AI compute nodes or the one or more pods; and displaying, via the graphical user interface, the one or more percent of potential improvement recommendations generated for the AI compute system in association with the one or more explainability artifacts and the percent of potential value.

In one embodiment, the current compute performance of the AI compute system specifies a current job throughput performance of the AI compute system, and the computer-implemented method further comprises: computing, based in part on the current job throughput performance of the AI compute system, a first time duration required to complete a target set of AI workloads; computing, using the one or more processors, a projected job throughput performance of the AI compute system expected from implementation of the one or more percent of potential improvement recommendations within the AI compute system; computing, based in part on the projected job throughput performance of the AI compute system, a second time duration required to complete the target set of AI workloads; generating, by the one or processors, a comparative throughput artifact that graphically depicts: the target set of AI workloads completed in the first time duration based on the current job throughput performance of the AI compute system, and the target set of AI workloads completed in the second time duration based on the projected job throughput performance of the AI compute system; and displaying, via the graphical user interface, the comparative throughput artifact in association with the percent of potential value computed for the AI compute system and the one or more percent of potential improvement recommendations.

In one embodiment, the computer-implemented method further includes in response to generating the one or more explainability artifacts, automatically assessing, by the one or more processors, the one or more explainability artifacts; detecting, based on the assessment of the one or more explainability artifacts, that a bandwidth value associated with a respective AI compute node of the one or more AI compute nodes is below a predetermined minimum bandwidth threshold for a plurality of distinct test iterations; in response to detecting that the bandwidth value associated with the respective AI compute node is below the predetermined minimum bandwidth threshold, automatically generating a percent of potential improvement recommendation that (i) indicates a persistent bandwidth degradation affecting the respective AI compute node and (ii) proposes removing dust accumulated on a cable coupled to the respective AI compute node to resolve the persistent bandwidth degradation; and removing, based on the generated percent of potential improvement recommendation, the dust accumulated on the cable to resolve the persistent bandwidth degradation detected at the respective AI compute node.

In one embodiment, the computer-implemented method further includes: in response to generating the one or more explainability artifacts, automatically assessing, by the one or more processors, the one or more explainability artifacts; detecting, based on the assessment of the one or more explainability artifacts, that: a first bandwidth value observed during a first test iteration of a respective AI compute node of the one or more AI compute nodes is below a predetermined minimum bandwidth threshold, and a second bandwidth value observed during a second test iteration of the respective AI compute node satisfies the predetermined minimum bandwidth threshold; in response to detecting that the first bandwidth value observed during the first test iteration is below the predetermined minimum bandwidth threshold and the second bandwidth value observed during the second test iteration satisfies the predetermined minimum bandwidth threshold, automatically generating a percent of potential improvement recommendation that specifies an intermittent bandwidth degradation associated with the respective AI compute node and proposes reseating a cable coupled to the respective AI compute node to resolve the intermittent bandwidth degradation; and reseating, based on the generated percent of potential improvement recommendation, the cable to resolve the intermittent bandwidth degradation associated with the respective AI compute node.

In one embodiment, the computer-implemented method further includes in response to generating the one or more explainability artifacts, automatically assessing, by the one or more processors, the one or more explainability artifacts and the compute infrastructure data; detecting, based on the assessment of the one or more explainability artifacts and the compute infrastructure data, that firmware installed on the one or more AI compute nodes deviates from an expected firmware version specified in a compute architecture object corresponding to the AI compute system; in response to detecting that the firmware deviates from the expected firmware version, automatically generating a percent of potential improvement recommendation that specifies updating the firmware installed on the one or more AI compute nodes to conform to the expected firmware version; and automatically updating, based on the generated percent of potential improvement recommendation, the firmware installed on the one or more AI compute nodes to conform to the expected firmware version.

In one embodiment, the computer-implemented method further includes before generating the one or more explainability artifacts: automatically detecting, based on the compute infrastructure data and the current compute performance of the AI compute system, that a respective pod of the one or more pods is operating below a predetermined pod-level performance threshold; and in response to detecting that the respective pod is operating below the predetermined pod-level performance threshold, automatically identifying, using the compute infrastructure data and the current compute performance of the AI compute system, at least one AI compute node within the respective pod causing the respective pod to operate below the predetermined pod-level performance threshold.

In one embodiment, a first explainability artifact of the one or more explainability artifacts graphically indicates the respective pod is operating below the predetermined pod-level performance threshold; and a second explainability artifact of the one or more explainability artifacts graphically indicates the at least one AI compute node of the respective pod causes the respective pod to operate below the predetermined pod-level performance threshold.

In one embodiment, the AI compute system corresponds to an AI data center constructed at a target geographic location, the AI data center includes a plurality of distinct AI compute nodes, wherein each AI compute node of the plurality of distinct AI compute nodes includes one or more central processing units, a plurality of graphics processing units, and memory, and the AI data center further includes networking hardware that physically couples the plurality of distinct AI compute nodes to enable data communication between the plurality of distinct AI compute nodes.

In one embodiment, the computer-implemented method further includes after computing the percent of potential value for the AI compute system, automatically generating, based in part on the compute infrastructure data and the current compute performance of the AI compute system, a plurality of distinct recommendations configured to improve the compute performance of the AI compute system; periodically monitoring the AI compute system over a predetermined time span and during the predetermined time span: implementing, over a plurality of distinct time intervals within the predetermined time span, the plurality of distinct recommendations within the AI compute system; and automatically computing a plurality of subsequent percent of potential values for the AI compute system across the plurality of distinct time intervals; generating, using the one or more processors, a first time-series artifact graphically representing a temporal progression of the plurality of subsequent percent of potential values across the plurality of distinct time intervals; and generating, using the one or more processors, a second time-series artifact that superimposes the temporal progression of the plurality of subsequent percent of potential values with graphical indicators marking respective implementation times of the plurality of distinct recommendations within the predetermined time span; and displaying, in response to generating the first time-series artifact and the second time-series artifact, the first time-series artifact and the second time-series artifact on the graphical user interface.

In one embodiment, generating the one or more explainability artifacts includes automatically generating a pod-level performance assessment artifact that graphically represents pod performance metrics for a plurality of distinct pods of the AI compute system, wherein each distinct pod of the plurality of distinct pods includes a plurality of distinct AI compute nodes, the graphical user interface displays the pod-level performance assessment artifact, and the computer-implemented method further comprising: receiving, via the graphical user interface, an input from the subscribing entity selecting a graphical region of the pod-level performance assessment artifact that corresponds to a target pod of the plurality of distinct pods; in response to receiving the input selecting the graphical region corresponding to the target pod: obtaining, in real-time or near real-time, the respective compute node identifier of each AI compute node of the plurality of distinct AI compute nodes included in the target pod; obtaining, using the respective compute node identifier corresponding to each AI compute node of the plurality of distinct AI compute nodes included in the target pod, node-level performance metrics associated with each AI compute node included in the target pod; dynamically generating, using the node-level performance metrics, a node-level assessment artifact that graphically represents the node-level performance metrics associated with the plurality of distinct AI compute nodes included in the target pod; and updating the graphical user interface from displaying the pod-level performance assessment artifact to displaying the node-level assessment artifact; and while displaying the node-level assessment artifact on the graphical user interface: receiving, via the graphical user interface, an input from the subscribing entity selecting a graphical region of the node-level assessment artifact that corresponds to a target AI compute node of the plurality of distinct AI compute nodes included in the target pod; and in response to receiving the input from the subscribing entity selecting the graphical region corresponding to the target AI compute node: identifying, based in part on the node-level performance metrics associated with the target AI compute node, a performance degradation condition associated with the target AI compute node in real-time or near real-time, and automatically executing, based on the performance degradation condition, a node repair action to resolve the performance degradation condition associated with the target AI compute node in real-time or near real-time.

In one embodiment, the computer-implemented method further includes determining, based on the compute infrastructure data associated with the AI compute system, a compute architecture profile corresponding to the AI compute system; retrieving, from a peer performance repository, one or more peer percent of potential values that correspond to one or more peer AI compute systems having an architecture profile equivalent to the compute architecture profile determined for the AI compute system; and in response to retrieving the one or more peer percent of potential values, displaying, via the graphical user interface, the one or more peer percent of potential values in association with the percent of potential value computed for the AI compute system and the one or more explainability artifacts.

In one embodiment, a computer-implemented system includes: one or more processors; a memory; a computer-readable medium operably coupled to the one or more processors, the computer-readable medium having computer-readable instructions stored thereon that, when executed by the one or more processors, cause a computing device to perform operations comprising: receiving, via a computer network, a request to assess compute performance of an AI compute system that executes AI workloads for a subscribing entity; obtaining, in response to receiving the request, compute infrastructure data associated with the AI compute system, wherein the compute infrastructure data includes at least: a corpus of compute node identifiers that includes a respective compute node identifier for each AI compute node of the AI compute system; in response to obtaining the compute infrastructure data associated with the AI compute system: automatically computing, using the compute infrastructure data, a maximum compute performance obtainable by the AI compute system; automatically executing, using the one or more processors, one or more compute performance tests on the AI compute system to determine a current compute performance of the AI compute system; and automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system; automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein: the percent of potential value computed for the AI compute system indicates a degree to which the AI compute system is operating below the maximum compute performance obtainable by the AI compute system; and generating, in response to computing the percent of potential value, one or more explainability artifacts that graphically identify one or more AI compute nodes or one or more pods within the AI compute system that cause the AI compute system to operate below the maximum compute performance; and displaying, via a graphical user interface, the percent of potential value computed for the AI compute system in association with the one or more explainability artifacts.

In one embodiment, computing the percent of potential value includes computing an AI node availability value of the AI compute system based on a ratio between the total number of AI compute nodes online in the AI compute system and the total number of AI compute nodes included in the AI compute system, computing a compute utilization value of the AI compute system based on a ratio between the current compute performance of the AI compute system and the maximum compute performance obtainable by the AI compute system, and computing the percent of potential value for the AI compute system by multiplying the AI node availability value by the compute utilization value.

In one embodiment, a computer-program product comprising a non-transitory machine-readable storage medium storing computer instructions that, when executed by processing circuitry, perform operations including: receiving, via a computer network, a request to assess compute performance of an AI compute system that executes AI workloads for a subscribing entity; obtaining, in response to receiving the request, compute infrastructure data associated with the AI compute system, wherein the compute infrastructure data includes at least: a corpus of compute node identifiers that includes a respective compute node identifier for each AI compute node of the AI compute system; in response to obtaining the compute infrastructure data associated with the AI compute system: automatically computing a maximum compute performance obtainable by the AI compute system; automatically executing, using one or more processors, one or more compute performance tests on the AI compute system to determine a current compute performance of the AI compute system; and automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system; automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein: the percent of potential value computed for the AI compute system indicates a degree to which the AI compute system is operating below the maximum compute performance obtainable by the AI compute system; and generating, in response to computing the percent of potential value, one or more explainability artifacts that graphically identify one or more AI compute nodes or one or more pods within the AI compute system that cause the AI compute system to operate below the maximum compute performance; and displaying, via a graphical user interface, the percent of potential value computed for the AI compute system in association with the one or more explainability artifacts.

In one embodiment, automatically computing the maximum compute performance obtainable by the AI compute system includes identifying, based on the compute infrastructure data associated with the AI compute system, a respective compute architecture profile corresponding to the AI compute system; and retrieving, from a compute performance repository, a reference maximum compute performance value associated with the respective compute architecture profile based on querying the compute performance repository using the respective compute architecture profile as a search parameter; wherein: the maximum compute performance obtainable by the AI compute system corresponds to the reference maximum compute performance value associated with the respective compute architecture profile.

In one embodiment, the computer instructions, when executed by the processing circuitry, perform operations further comprising: providing the compute infrastructure data and the one or more explainability artifacts as input to an analytical model; automatically generating, using the analytical model, one or more percent of potential improvement recommendations for the AI compute system based on assessment of the compute infrastructure data and the one or more explainability artifacts; and displaying, via the graphical user interface, the one or more percent of potential improvement recommendations in association with the percent of potential value computed for the AI compute system and the one or more explainability artifacts.

### BRIEF DESCRIPTION OF THE FIGURES

FIG. 1 illustrates a schematic representation of a system for enhanced cluster health management in accordance with one or more embodiments of the present application;

FIG. 1A illustrates a schematic representation of a subsystem for generating and scoring subscriber-specific compute architectures in accordance with one or more embodiments of the present application;

FIG. 1B illustrates a schematic representation of a subsystem for assessing and scoring subscriber-implemented high-performance compute architectures in accordance with one or more embodiments of the present application;

FIG. 2 illustrates an example method for assessing and scoring subscriber-implemented high-performance compute architectures in accordance with one or more embodiments of the present application;

FIG. 3 illustrates an example of determining an optimal performance of a subscriber-implemented high-performance compute architecture in accordance with one or more embodiments of the present application;

FIG. 4 illustrates an example of determining a current performance of a subscriber-implemented high-performance compute architecture in accordance with one or more embodiments of the present application;

FIG. 5 illustrates an example of determining a percent of potential score for a subscriber-implemented high-performance compute architecture in accordance with one or more embodiments of the present application; and

FIGS. 6-12 illustrate examples of a graphical user interface in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

The systems, methods, computer-program products, and apparatuses described herein may be used across a broad range of high-performance computing (HPC) infrastructure design and compute performance optimization applications. In particular, some of the systems, methods, computer-program products, and apparatuses may function to automatically compute, in real-time or near real-time, a percent of potential (PoP) value for an AI compute system (e.g., AI factory, AI data center, etc.) that quantifies a degree to which the AI compute system operates below a maximum obtainable compute performance. As described in more detail herein, computing the PoP score (e.g., PoP value) for the AI compute system and generating associated explainability artifacts provides many technical benefits and advantages over conventional systems.

Traditional systems and methods are ill-equipped for assessing compute infrastructure accurately. This is due to the inherently complex and highly interdependent nature of modern high-performance computing environments (e.g., AI compute systems, AI factories, AI data centers, etc.), where diverse hardware components and software components interact in ways that can significantly affect overall compute performance and compute efficiency. As a result, such traditional systems and methods are unable to detect and explain how specific AI compute nodes, pods, networking components, firmware configurations, or other infrastructure elements contribute to reductions in overall compute performance relative to a maximum compute performance (e.g., optimal compute performance or the like) expected to be obtained by a respective AI compute system.

Conversely, the systems, methods, computer-program products, and apparatuses described herein enable AI compute infrastructure explainability by programmatically surfacing how specific AI compute nodes, pods, networking components, and/or firmware configurations contribute to detected reductions in overall compute performance relative to a maximum obtainable compute performance. For instance, some of the systems, methods, computer-program products, and apparatuses described herein may function to automatically compute, in real-time or near real-time, a percent of potential (PoP) value for an AI compute system based on both node availability and compute utilization, and generate interactive user interface (UI) explainability artifacts that visually and/or textually identify which AI compute nodes or pods are responsible for reductions in compute performance relative to the maximum compute performance (e.g., optimal performance) obtainable by the AI compute system. In other words, the embodiments described herein provide an improvement over traditional systems and methods by at least automatically detecting performance-limiting (or degraded) AI compute nodes or pods within a target AI compute system, computing a PoP value of the AI compute system based on both architectural capacity and measured performance, and generating interactive UI objects that textually or graphically explain which specific infrastructure components are responsible for performance degradation and how each respective component contributes to the computed PoP value.

Another technical advantage of the systems, methods, computer-program products, and apparatuses described herein includes the ability to iteratively optimize an AI compute system until a computed percent of potential (PoP) value satisfies or exceeds a predetermined minimum PoP threshold value. In some embodiments, the disclosed systems periodically compute, in real-time or near real-time, updated PoP values for the AI compute system based on node availability, current compute performance, and maximum obtainable compute performance. In response to determining that the PoP value does not satisfy the predetermined minimum PoP threshold value, the system may automatically generate one or more percent-of-potential improvement recommendations configured to mitigate detected performance-limiting conditions affecting one or more AI compute nodes (e.g., compute nodes) or pods. In certain embodiments, corrective actions corresponding to the percent-of-potential improvement recommendations may be automatically executed by the system or implemented by a user. After each corrective action or infrastructure modification, the system may automatically recompute the PoP value to determine whether the AI compute system, as modified, satisfies the predetermined minimum PoP threshold value, thereby forming a closed-loop performance optimization process.

It shall be recognized that, in some embodiments, implementing corrective actions within the AI compute system may include performing physical and/or programmatic modifications to infrastructure components of a real-world AI data center (e.g., the AI compute system). For example, corrective actions may include restoring connectivity of an AI compute node, addressing persistent or intermittent bandwidth degradation associated with a networking cable, removing dust or other physical contaminants accumulated on a cable or connector coupled to an AI compute node to resolve signal degradation, reseating a cable to improve electrical contact, updating firmware to conform to an expected compute architecture profile, reconfiguring workload scheduling parameters, or modifying orchestration settings. The AI compute system may include a plurality of AI compute nodes, each comprising one or more central processing units (CPUs), a plurality of graphics processing units (GPUs), memory resources, and associated networking hardware that physically interconnects the plurality of AI compute nodes. In some embodiments, execution of the corrective actions results in physical changes to hardware components—including cleaning, reseating, replacing, or otherwise physically modifying interconnect components—and/or programmatic reconfiguration of software components and/or software modules operating within the AI compute system.

As a result, the systems, methods, computer-program products, and apparatuses described herein provide an improvement over traditional systems by enabling automated, performance-aware remediation of real-world AI compute systems. By iteratively computing PoP values and linking detected performance disparity conditions to targeted corrective actions (e.g., percent of potential improvement recommendations), the disclosed embodiments improve compute resource utilization, increase effective node availability, enhance bandwidth efficacy, and improve workload throughput across the AI compute system. In particular, by reducing the duration during which AI compute nodes operate below their maximum obtainable compute performance (e.g., optimal performance), the disclosed systems decrease infrastructure downtime, reduce inefficient resource allocation, and enhance overall operational efficiency of physically deployed AI data centers relative to conventional systems.

Another technical benefit of the systems, methods, computer-program products, and apparatuses described herein includes the ability to interactively assess and remediate performance conditions of an AI compute system using a graphical user interface. Conventional systems do not provide mechanisms for dynamically correlating node-level health, pod-level performance metrics, and maximum obtainable compute capacity into a unified, performance-aware interface that enables targeted remediation. Conversely, the systems, methods, computer-program products, and apparatuses described herein enable users to assess, visualize, and address infrastructure-level performance conditions through interactive graphical user interfaces, as described in more detail herein. In some embodiments, the graphical user interfaces described herein include performance-guided visualization mechanisms that simultaneously display a computed percent of potential (PoP) value and one or more explainability artifacts identifying performance-limiting (e.g., degraded) AI compute nodes or pods. The graphical user interface may further allow a user to select a graphical region corresponding to a target pod or AI compute node, dynamically retrieve corresponding node-level performance metrics in real-time or near real-time, and generate drill-down assessment artifacts that expose component-specific degradation conditions. In certain embodiments, the graphical user interface may further present corrective action recommendations (e.g., percent of potential improvement recommendations) and enable initiation of remediation actions directly from the graphical user interface.

It shall be further recognized that, in some embodiments, the graphical user interfaces described herein may further enable intuitive exploration of detected AI compute system performance deviations. For example, once a percent of potential (PoP) value is computed for an AI compute system, the system or service may surface graphical and/or textual indicators that identify specific AI compute nodes, pods, or infrastructure components contributing to reductions in the computed PoP value relative to a maximum obtainable compute performance. In some embodiments, these deviations may be presented as interactive user interface elements within the graphical user interface, allowing a user to select a performance-limiting pod, drill down into node-level performance metrics, and isolate specific degradation conditions—such as reduced bandwidth efficacy, node unavailability, or firmware deviation—in a guided manner. In one or more embodiments, selection of an identified performance-limiting (e.g., defective or the like) component may cause the system to dynamically retrieve real-time or near real-time performance metrics associated with the selected component and present contextual remediation recommendations (e.g., PoP improvement recommendations or the like) directly within the graphical user interface. By enabling interactive exploration of node-level and pod-level performance deviations in association with the computed PoP value, the disclosed systems reduce the cognitive and computational burden associated with log analysis. Therefore, the systems, methods, computer-program products, and apparatuses described herein provide an improvement over conventional systems by enabling not only low-friction visualization of overall AI compute system performance, but also intuitive, performance-aware exploration and controlled remediation of infrastructure components that limit compute performance within a physically deployed AI data center.

Accordingly, the systems, methods, computer-program products, and apparatuses described herein provide an improvement over traditional systems by enabling faster detection and remediation of performance-limiting conditions, degraded components, and/or defective components within an AI compute system, reducing the total number of user inputs needed to diagnose performance degradation, reducing the total number of investigative steps required to identify root causes of infrastructure underperformance, and/or reducing the total amount of time for which a graphical user interface must remain instantiated to assess and resolve compute performance issues. It shall be recognized that, in some embodiments, the longer a graphical user interface remains instantiated on a computing device—particularly a battery-powered computing device (e.g., a laptop, tablet, or mobile device used by an administrator)—the more processing resources (e.g., CPU cycles, memory usage, graphics processing utilization, and I/O operations) are consumed, which in turn increases power draw and accelerates battery depletion. By automatically computing percent of potential (PoP) values, generating explainability artifacts, surfacing targeted remediation recommendations, and enabling guided drill-down into performance-limiting (or defected) AI compute nodes or pods, the disclosed systems reduce the need for log analysis and user interface (UI) navigation. Accordingly, reducing the number of user inputs and shortening the duration of graphical user interface instantiation improves utilization of underlying computing resources (e.g., reduced processor load, reduced memory allocation, fewer interface rendering operations, and reduced input/output activity), thereby improving system efficiency, responsiveness, and overall resource utilization during AI compute infrastructure assessment and optimization tasks.

### 1.0 System for Enhanced Cluster Health Management

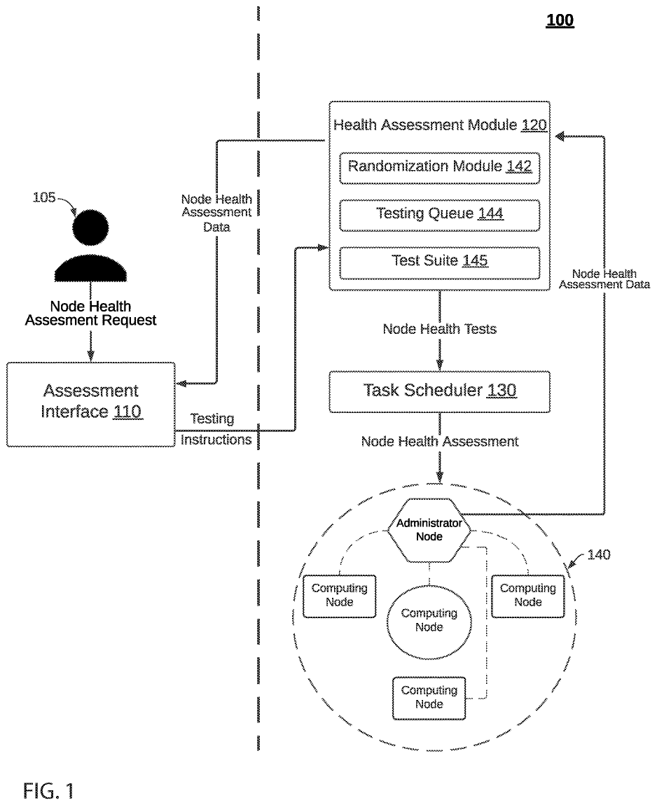

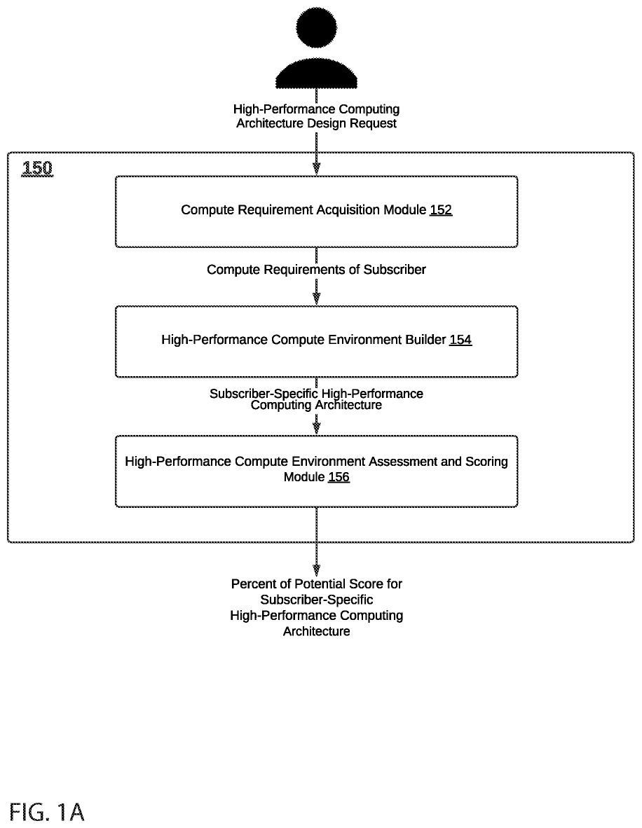

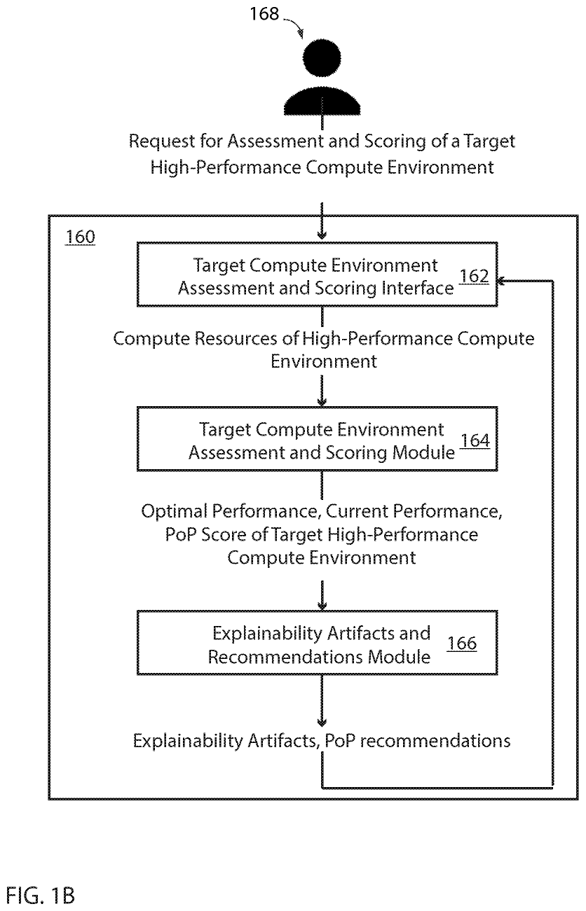

As shown in FIG. 1, a system 100 implementing enhanced cluster health management and for detecting unhealthy computing nodes within a cluster of computer nodes includes a node health assessment interface 110, a health assessment module 120, and a task scheduler 130 for assessing the health of a cluster of computing nodes 140.

### 1.1 Computing Node Health Assessment Interface

The node health assessment interface 110, preferably includes a command interface or system programming interface or console through which an administrator 105 may operate to execute a node health assessment of a target cluster of computing nodes 140. In a preferred embodiment, the node health assessment interface 110 is preferably implemented by one or more computers and may be in operable control communication with one or more computing nodes of a target cluster of computing systems. In such preferred embodiment, the node health assessment interface may function to receive, as input, one or more user commands for executing one or more aspects of a node health assessment of a target cluster of computing nodes 140 and output control signals to the one or more computing nodes of the target cluster of computing nodes 140.

In one or more embodiments, the one or more computing nodes of a target cluster of computing nodes 140 that may be operably controlled via the node health assessment interface 110 preferably include an administrator node. In such embodiments, the administrator node comprises one computing node of the target cluster of computing nodes 140 that may be in network communication with all computing nodes of the target cluster of computing nodes 140. The administrator node executing commands or instructions from the node health assessment interface 110 may function to administer any suitable tests to the target cluster of computing nodes 140 including, but not limited to, a node health assessment. In some embodiments, the administrator node may be referred to herein as a head node or a control node depending on its operation within the cluster of computing nodes 140. Accordingly, the administrator node 105 may have installed cluster management software or similar applications that preferably enables the administrator node 105 to coordinate activities of the cluster of computing nodes 140, manage resource allocation, perform scheduling (e.g., integrated scheduler 130), and/or support maintaining an overall health of the cluster of computing nodes 140.

Additionally, or alternatively, the administrative node may be in operable control communication of a parallel file system or the like for administering any suitable tests, including a node health assessment, to a target cluster of computing nodes 140. Additionally, or alternatively, the administrative node may include an assessment agent installed thereon that may be in communication and operably controlled via commands from the node health assessment interface 110. In some embodiments, the assessment agent of the administrator node based on command inputs from the node health assessment interface 110 may function to automatically execute one or more operations or functions of a node health assessment against a target cluster of computing nodes 140.

### 1.2 Health Assessment Module

The health assessment module 120, in one or more embodiments, which is in operable communication with one or more of the node health assessment interface 110, the node assessment scheduler 130, and cluster of computing nodes 140 may operate to configure one or more node health assessments and/or execute one or more node health assessments against a target set of computing nodes of the cluster of computing nodes 140. In one or more embodiments, the health assessment module 120 may function to store and/or have access to a test suite 145, which is sometimes referred to herein as a pool of node health tests, that includes a plurality of node health tests. At runtime, the health assessment module 120 may function to source from the test suite 145 one or more node health tests, which may be executed either serially or in parallel against computing nodes of the cluster of computing nodes 140.

In one or more embodiments, the health assessment module 120 may be implemented in cooperation with a network file system, a parallel file system or the like. In such embodiments, the health assessment module 120 may be implemented by an administrative computing node of a target cluster of computing nodes, the administrative computing node may be sometimes referred to herein as a “head node” or “node zero”. Additionally, or alternatively, each computing node in the target cluster of computing nodes may store a copy of the tests and/or assessments associated with an operation of the health assessment module 120. In this way, commands and/or signals from the health assessment module 120 may cause any or each of the computing nodes of the target cluster to access one or more tests and/or assessments and execute the tests or assessments concurrently. In such embodiments, the outputs of the execution of the tests and/or assessments by the target cluster of computing nodes may be stored to or served out to the network file system.

Additionally, or alternatively, the health assessment module 120 may function to implement and/or include one or more of a randomization module 142 and a testing queue 144 that may operate together for initializing and executing a node health assessment of computing nodes of a cluster of computing nodes 140. In one or more embodiments, the randomization module 142 may function to ensure that different first computing nodes are seeded to prevent biased results on the basis of an initial computing node selection from a batch of computing nodes subject to a node health assessment.

### 1.3 Automated Task Scheduler

The task scheduler 130 preferably functions as an orchestration layer that automatically facilitates a node health assessment. In a preferred embodiment, the task scheduler 130 may function to integrate node health assessments directly into an operational workflow of the cluster of computing nodes 140. Accordingly, the task scheduler 130 may be multi-faceted in its automated application of node health assessments on a predetermined schedule or dynamically during a pre-job deployment of a batch of computing nodes.

In one or more embodiments, the task scheduler 130 may function to continually and/or periodically monitor a state of computing nodes within the cluster of computing nodes 140 to identify idle computing nodes that are not currently allocated to user jobs. In such embodiments, the task scheduler 130 may batch the idle computing nodes to the node testing queue 144 for a node health assessment.

### 1.4 Cluster of Computing Nodes

The cluster of computing nodes 140 preferably includes a plurality of distinct computing nodes where each distinct node comprises a computer. In a preferred embodiment, the computer typically includes a server-grade machine, equipped with one or more of central processing units (CPUs), graphical processing units (GPUs), both, or similar processing components capable of executing tasks and running applications. In one or more embodiments, the plurality of distinct computing nodes in a cluster may include network interconnects comprising high-speed communication pathways that link the computing nodes together, facilitating rapid data transfer. One or more examples of network interconnects may include, but should not be limited to, InfiniBand, Ethernet, fiber-optic connections that may enable the computing nodes to operate in concert for distributed computing tasks.

Additionally, or alternatively, a cluster of computing nodes may include a storage system having an associated memory or data storage solutions that may range from local disk drives within each computing node of the cluster of computing nodes 140 to shared storage systems, such as storage area network (SAN) or network attached storage (NAS), accessible by all computing nodes in cluster 140 for distributed file systems and data persistence. In a preferred embodiment, the cluster of computing nodes 140 preferably employs a parallel file system that allows multiple computing nodes to access and process data simultaneously, which may increase throughput and efficiencies of the computing nodes.

### 1.5 System for Generating and Scoring Subscriber-Specific Compute Architectures

As shown in FIG. 1A, a subsystem 150 (of the system 100) for generating and scoring subscriber-specific compute architectures may include a compute requirement acquisition module 152, a subscriber-specific high-performance compute environment builder 154, and a subscriber-specific high-performance compute environment assessment and scoring module 156. It shall be noted that subsystem 150 may operate independently of system 100 or in conjunction with system 100.

The compute requirement acquisition module 152, in one or more embodiments, may function to receive a high-performance computing architecture design request (e.g., AI compute architecture design request or the like) from a subscriber and output a set of compute requirements associated with the subscriber. The set of compute requirements may inform or control a design or generation of a high-performance computing architecture (e.g., AI compute architecture) requested by the subscriber. The set of compute requirements outputted by the compute requirement acquisition module 152, in some embodiments, may specify minimum performance thresholds likely needed for a target computing environment (e.g., high-performance computing environment, AI compute environment, etc.) to operate effectively under expected workloads and computational tasks of the subscriber.

The subscriber-specific high-performance compute environment builder 154, in one or more embodiments, may function to receive, as input, the set of compute requirements associated with the subscriber (or a representation of the set of compute requirements) and output a subscriber-specific high-performance computing architecture (e.g., subscriber-specific AI compute architecture) based on the set of compute requirements. The subscriber-specific high-performance computing architecture may define the infrastructure or configuration of hardware components and software components likely needed to satisfy computational demands and use cases of the subscriber. The subscriber-specific high-performance compute environment builder 154 may function to generate the subscriber-specific high-performance computing architecture by assessing the set of compute requirements associated with the subscriber and mapping each compute requirement of the set of compute requirements to one or more hardware components and/or one or more software components. It shall be recognized that “subscriber-specific high-performance compute environment builder 154” may be interchangeably referred to herein as an “AI compute environment builder” or the like.

The subscriber-specific high-performance compute environment assessment and scoring module 156, in one or more embodiments, may function to receive the subscriber-specific high-performance computing architecture (e.g., the subscriber-specific AI compute architecture or the like) and output a percent of potential (PoP) score computed for the subscriber-specific high-performance computing architecture. The subscriber-specific high-performance compute environment assessment and scoring module 156, in one or more embodiments, may function to compute the PoP score for the subscriber-specific high-performance computing architecture by evaluating the subscriber-specific high-performance computing architecture against a target reference compute architecture. Additionally, or alternatively, in one or more embodiments, the subscriber-specific high-performance compute environment assessment and scoring module 156, in one or more embodiments, may function to compute the PoP score for the subscriber-specific high-performance computing architecture by evaluating the theoretical performance of the subscriber-specific high-performance computing architecture against the published performance of the target reference compute architecture. It shall be recognized that “subscriber-specific high-performance compute environment assessment and scoring module 156” may be interchangeably referred to herein as an “AI compute environment assessment and scoring module” or the like.

### 1.6 System for Assessing and Scoring Subscriber-Implemented High-Performance Compute Architectures

FIG. 1B illustrates a non-limiting example of a subsystem 160 (of the system 100 or subsystem 150) for assessing and scoring subscriber-implemented compute architectures including a target compute architecture assessment and scoring interface 162, a target compute architecture assessment and scoring module 164, and an explainability artifacts and recommendations module 166. It shall be noted that subsystem 160 may operate independently of in conjunction with one or more of system 100 and subsystem 150. It shall be further noted that subsystem 160 may be embodied and/or implemented at least in part as a machine configured to receive a computer-readable medium storing computer-readable instructions (e.g., computer program code, algorithm). The computer-readable instructions when executed by one or more processors and/or controllers may effectuate one or more functions of the subsystem 160 described herein.

In one or more embodiments, a subscriber-implemented high-performance compute architecture, which may also be referred to herein as a target compute architecture or the like, may relate to or correspond to a currently implemented real-world compute environment comprising at least a cluster of computing nodes and network interconnects linking the computing nodes within the cluster together. The cluster of computing nodes may include a plurality of distinct computing nodes, wherein each computing node includes a computer. In some embodiments, one or more of the computing nodes may comprise an artificial intelligence (AI) node, such as a computer configured to execute AI operations. In one or more embodiments, the computer may include a server-grade machine, equipped with one or more of CPUs, GPUs, both, or similar processing components capable of executing tasks and running applications. Examples of such tasks may include, but are not limited to, simulation and modeling, large dataset analysis, large data processing, cybersecurity related tasks, cryptography related tasks, and AI and machine learning related tasks such as training deep learning models on large datasets (e.g., large language models (LLMs), convolutional neural networks (CNNs), recurrent neural networks (RNNs), etc.), predictive AI, and autonomous systems and robotics and/or any other suitable type of compute task without departing from the scope of the disclosure. Examples of such applications may include, but are not limited to, applications used in the execution of the above-noted tasks. In some embodiments, the cluster of computing nodes may include a storage system having associated memory or data storage solutions that may range from local disk drives within each computing node of the cluster to shared storage systems, such as a SAN or a NAS, accessible by all computing nodes in the cluster for distributed file systems and data persistence. In some embodiments, the cluster of computing nodes may employ a parallel file system that allows multiple computing nodes to access and process data simultaneously. In one or more embodiments, the network interconnects may comprise high-speed communication pathways linking the computing nodes within the cluster together, facilitating rapid data transfer. Examples of network interconnects may include, but are not limited to, InfiniBand, Ethernet, and fiber-optic connections that may enable the computing nodes to operate in concert for distributed computing tasks.

### Target Compute Architecture Assessment and Scoring Interface

In one or more embodiments, the target compute architecture assessment and scoring interface 162 may include a command interface or system programming interface or console through which an administrator and/or subscriber 168 may interact with the subsystem 160. In one or more embodiments, the target compute architecture assessment and scoring interface 162 may be implemented by one or more computers and may be in operable communication with the target compute architecture assessment and scoring module 164. In one or more embodiments, a graphical user interface (GUI) of the target compute architecture assessment and scoring interface 162 may function to receive, as input, from the administrator and/or subscriber 168, one or more of compute resources associated with a target compute architecture (or a compute environment corresponding thereto) and one or more requests for executing one or more aspects of the assessing and scoring of the target compute architecture. Compute resources associated with the target compute architecture (or the compute environment corresponding thereto) may include, but are not limited to, existing compute nodes (e.g., CPUs, GPUs), network interconnects, network bandwidth specifications, memory configurations, storage capacity, etc. The existing set of compute nodes may indicate a total number of compute nodes within the compute environment corresponding to the target compute architecture and a number of the compute nodes within the compute environment corresponding to the target compute architecture that are online. In one or more embodiments, the GUI of the target compute architecture assessment and scoring interface 162 may function to further receive, as input, from the administrator and/or subscriber 168, optimal performance metrics (e.g., expected performance metrics associated with the target compute architecture as currently configured (or the compute environment corresponding thereto) and current performance metrics associated with the target compute architecture (or the compute environment corresponding thereto) (e.g., actual performance metrics associated with the compute environment corresponding with the target compute architecture as currently configured).

In one or more embodiments, the target compute architecture assessment and scoring interface 162 may further function to communicate one or more of the compute resources, the optimal performance metrics associated with the target compute architecture (or the compute environment corresponding thereto), and the current performance metrics associated with the target compute architecture (or the compute environment corresponding thereto) to the target compute architecture assessment and scoring module 164.

In one or more embodiments, the target compute architecture assessment and scoring interface 162 may be in operable communication with the explainability artifacts and recommendations module 166 and may function to display, via the GUI, explainability artifacts and recommendations.

### Target Compute Architecture Assessment and Scoring Module

In one or more embodiments, the target compute architecture assessment and scoring module 164 may function to execute the one or more aspects of the assessing and scoring of the target compute architecture (e.g., subscriber-implemented compute architecture or the like). In one or more embodiments, the target compute architecture may include, correspond to, or be a representation of a currently implemented real-world high-performance compute environment (e.g., AI data center, supercomputing center, telecommunication center, cloud computing center, etc.). In one or more embodiments, the target compute architecture assessment and scoring module 164 may be in operable communication with the target compute architecture assessment and scoring interface 162. In one or more embodiments, the target compute architecture assessment and scoring module 164 may function to execute the one or more aspects of the assessing and scoring of the target compute architecture upon receiving the compute resources from the target compute architecture assessment and scoring interface 162. In one or more embodiments, the target compute architecture assessment and scoring module 164 may function to autonomously source the compute resources associated with the target compute architecture (or the compute environment corresponding thereto), upon which the target compute architecture assessment and scoring module 164 may function to execute the one or more aspects of the assessing and scoring of the target compute architecture. The target compute architecture assessment and scoring module 164 may source the compute resources associated with the target compute architecture (or the compute environment corresponding thereto) periodically (e.g., hourly, daily, weekly, bi-weekly, monthly, bi-monthly, bi-yearly, etc.), upon detecting a compute resource change associated with the target compute architecture (or the compute environment corresponding thereto) and/or upon another condition being satisfied.

The one or more aspects of the assessing and scoring of the target compute architecture may include, but is not limited to, determining or identifying each of an optimal performance of the target compute architecture (or a high-performance compute environment that corresponds to the target compute architecture), a current performance of the target compute architecture (or the high-performance compute environment that corresponds to the target compute architecture), and a PoP score of the target compute architecture. The optimal performance of the target compute architecture may be understood as a maximum possible performance (or otherwise the best or most effective possible performance) that is obtainable by the target compute architecture (or the compute environment corresponding thereto) as currently configured while the current performance of the target compute architecture may be understood as the current performance obtained by the target compute architecture (or the compute environment corresponding thereto) as currently configured. In one or more embodiments, the PoP score of the target compute architecture may be an evaluation of the current performance of the target compute architecture (or the compute environment corresponding thereto) against the optimal performance of the target compute architecture (or the compute environment corresponding thereto).

In one or more embodiments, the target compute architecture assessment and scoring module 164 may function to receive the compute resources associated with the target compute architecture (or the compute environment corresponding thereto) from the target compute architecture assessment and scoring interface 162 and determine or identify the optimal performance of the target compute architecture (or the optimal performance of the compute environment corresponding to the target compute architecture), the current performance of the target compute architecture (or the current performance of the compute environment corresponding to the target compute architecture), and the PoP score of the target compute architecture. In one or more embodiments, the target compute architecture assessment and scoring module 164 may comprise one or more submodules for determining or identifying the optimal performance of the target compute architecture (or the compute environment corresponding thereto), determining or identifying the current performance of the target compute architecture (or the compute environment corresponding thereto), and determining the PoP score of the target compute architecture (or the corresponding compute environment).

In one implementation, the target compute architecture assessment and scoring module 164 may function to determine or identify the optimal performance of the target compute architecture (or the compute environment corresponding thereto) assuming a non-blocking network configuration (e.g., no congestion). For instance, in one or more embodiments, the target compute architecture assessment and scoring module 164 may function to determine or identify the optimal performance of the target compute architecture (or the compute environment corresponding thereto) based on an assumption that the compute resources (e.g., hardware-type compute resources, software-type compute resources, etc.) obtain maximum compute performance with no bottlenecks (e.g., hardware bottlenecks, software bottlenecks, etc.). In a second implementation, the target compute architecture assessment and scoring module 164, in one or more embodiments, may function to determine or identify the optimal performance of the target compute architecture (or the compute environment corresponding thereto) based on expected performance metrics associated with the target compute architecture (or compute environment corresponding thereto) (e.g., an expected compute environment bandwidth capacity of 3.2 terabits per second, etc.). In such embodiments, the target compute architecture assessment and scoring module 164 may function to search or lookup within a performance repository the one or more expected performance metrics associated with the target compute architecture (or compute environment corresponding thereto) from which the optimal performance of the target compute architecture (or compute environment corresponding thereto) may be identified.

In a third implementation, the target compute architecture assessment and scoring module 164 may function to determine or identify the optimal performance based on the target compute architecture (or the compute environment corresponding thereto) as currently configured. For instance, the optimal performance of the target compute architecture may be determined taking into consideration currently existing performance bottlenecks of the target compute architecture (or compute environment corresponding thereto) as currently configured. In one or more embodiments, the target compute architecture assessment and scoring module 164 may function to identify one or more performance bottlenecks within the target compute architecture (or compute environment corresponding thereto) and search or lookup within a performance degradation repository or any other suitable data structure a performance degradation factor associated with each performance bottleneck. In such embodiments, the target compute architecture assessment and scoring module 164 may function to apply a degradation factor associated with a performance bottleneck to the optimal performance of the target compute architecture (or the compute environment corresponding thereto) when operating without performance bottlenecks (e.g., the expected performance metrics associated with the target compute architecture or the corresponding compute environment assuming no performance bottlenecks). For instance, an expected FLOPS of the compute environment corresponding to the target compute architecture may be 25 FLOPS assuming the target compute architecture and the compute environment corresponding thereto is operating without performance bottlenecks. The target compute architecture assessment and scoring module 164 may function to determine the optimal performance of the target compute architecture (or the compute environment corresponding thereto) by applying a degradation factor associated with an identified performance bottleneck to the expected 25 FLOPS. In one or more embodiments, the performance degradation factor may be provided as a percentage or as a number between zero (0) to one (1). Where the performance degradation factor associated with a performance bottleneck is provided as a number between zero (0) to one (1), the target compute architecture assessment and scoring module 164 may function to apply the performance degradation factor by, for example, multiplying the difference between one (1) and the degradation factor with the optimal performance of the target compute architecture (or the compute environment corresponding thereto) when operating without performance bottlenecks or, by multiplying the sum of one (1) and the degradation factor with the optimal performance of the target compute architecture (or the compute environment corresponding thereto) when operating without performance bottlenecks. Where the performance degradation factor is provided as a percentage, the target compute architecture assessment and scoring module 164 may function to first divide the percentage by one hundred (100) to express the degradation factor as a number between zero (0) and one (1). In a non-limiting example, the compute environment corresponding to the target compute architecture may have a first performance bottleneck (e.g., congestion, misconfigured network settings, dust on cables, miswiring, etc.). Accordingly, the target compute architecture assessment and scoring module 164 may function to search or lookup within a performance degradation repository or any other suitable data structure a performance degradation factor associated with the first performance bottleneck. The target compute architecture assessment and scoring module 164 may function to identify that the first performance bottleneck is associated with a performance degradation factor of ten (10) percent based on searching the performance degradation repository. Accordingly, in such a non-limiting example, the target compute architecture assessment and scoring module 164 may function to determine that the optimal performance of the compute environment corresponding to the target compute architecture is ten (10) percent less than when operating without performance bottlenecks. Given the compute environment corresponding to the target compute architecture has a bandwidth capacity of 3.2 terabits per second when operating without performance bottlenecks, the target compute architecture assessment and scoring module 164 may determine that the optimal bandwidth capacity of the compute environment of the target compute architecture is 3.2×(1−(10/100))=2.88 terabits per second when operating with the first performance bottleneck. Various approaches for applying the performance degradation factor may be used in different embodiments.

In a fourth implementation, the target compute architecture assessment and scoring module 164 may function to determine or identify the optimal performance of the target compute architecture (or the compute environment corresponding thereto) based on optimal performance metrics received from the target compute architecture assessment and scoring interface 162, as provided by the administrator and/or subscriber 168 via the GUI of the target compute architecture assessment and scoring interface 162.

In one or more embodiments, the target compute architecture assessment and scoring module 164 may function to perform one or more performance tests on the compute environment corresponding to the target compute architecture and determine or identify the current performance of the target compute architecture (e.g., a representation of a currently implemented real-world high-performance compute architecture). For instance, the target compute architecture assessment and scoring module 164 may function to determine or identify the current performance of the compute environment corresponding to the target compute architecture based on performance metrics measured during one or more performance tests of the compute environment. In one example, a NVIDIA® Collective Communications Library (NCCL) all-reduce test may be performed on the compute environment corresponding to the target compute architecture. The NCCL all-reduce test may output a throughput performance metric that indicates the amount of data that can be processed per second, a latency performance metric that indicates the amount of time for the all-reduce operation to complete, and/or one or more scaling performance metrics that indicate the communication efficiency and computational workload distribution across multiple compute nodes of the compute environment corresponding to the target compute architecture (e.g., the representation of a currently implemented real-world high-performance compute architecture). In one or more embodiments, the target compute architecture assessment and scoring module 164 may function to determine or identify the current performance of the target compute architecture (or the compute environment corresponding thereto) based on current performance metrics associated with the target compute architecture (or the compute environment corresponding thereto) received from a separate software or system executing a suitable performance test and to which it is in operable communication with. It shall be noted that the current performance of the target compute architecture (or the compute environment corresponding thereto) may be measured using any suitable performance test.

In one or more embodiments, the target compute architecture assessment and scoring module 164 may function to determine or identify the current performance of the target compute architecture (or the compute environment corresponding thereto) based on current performance metrics associated with the target compute architecture (or the compute environment corresponding thereto) received from the target compute architecture assessment and scoring interface 162, as provided by the administrator and/or subscriber 168 via the GUI of the target compute architecture assessment and scoring interface 162.

In one or more embodiments, the target compute architecture assessment and scoring module 164 may function to perform one or more subscriber-specific performance tests on the compute environment corresponding to the target compute architecture. The target compute architecture assessment and scoring module 164 may function to determine or identify the current performance of the target compute architecture (or the compute environment corresponding thereto) based on one or more performance metrics measured during the one or more subscriber-specific performance tests.

It shall be noted that, in one or more embodiments, the target compute architecture assessment and scoring module 164 may function to determine or identify the optimal performance and the current performance of the target compute architecture (or the compute environment corresponding thereto) based on different types of performance metrics associated with the target compute architecture (or the compute environment corresponding thereto), including but not limited to, latency, processing speed, energy consumption rate, floating-point operations per second (FLOPS), job throughput, bandwidth, CPU/GPU utilization, and input/out performance, without departing from the full scope of the disclosure.

In one or more embodiments, the target compute architecture assessment and scoring module 164 may function to determine the PoP score for the target compute architecture (or the compute environment corresponding thereto) by evaluating the current performance of the target compute architecture (or the compute environment corresponding thereto) against the optimal performance (e.g., maximum compute performance) of the target compute architecture (or the compute environment corresponding thereto). In one or more embodiments, the target compute architecture assessment and scoring module 164 may function to determine and output the PoP score. In one or more embodiments, the target compute architecture assessment and scoring module 164 may function to determine the PoP score as the product of a compute node availability efficacy metric of the target compute architecture (or the compute environment corresponding thereto) and a performance efficacy metric of the target compute architecture (or the compute environment corresponding thereto) (i.e., PoP score=the compute node availability efficacy metric of the target compute architecture×the performance efficacy metric of the target compute architecture; or PoP score=the compute node availability efficacy metric of the compute environment×the performance efficacy metric of the compute environment). For example, given the compute node availability efficacy metric of the target compute architecture is 0.7 and the performance efficacy metric of the target compute architecture is 0.84, the PoP score is 0.7×0.84=0.59.

In one or more embodiments, the target compute architecture assessment and scoring module 164 may function to determine the compute node availability efficacy metric based on the compute resources associated with the target compute architecture (or the compute environment corresponding thereto), the compute resources may indicate the number of compute nodes online and the total number of compute nodes within the compute environment. In one or more embodiments, the target compute architecture assessment and scoring module 164 may function to determine the compute node availability efficacy metric of the target compute architecture (or the corresponding compute environment) as the ratio

$$\frac{the number of compute nodes online}{the total number of compute nodes} .$$

For example, given the number of compute nodes online is 70 and the total number of compute nodes is 100, the compute node availability efficacy metric (e.g., AI node availability value) of the target compute architecture (or the corresponding compute environment (e.g., AI compute system)) is 70/100=0.7.

In one or more embodiments, the target compute architecture assessment and scoring module 164 may function to determine the performance efficacy metric of the target compute architecture or the compute environment corresponding thereto) as the ratio

$$\frac{current performance of target compute architecture}{optimal performance of target compute architecture}$$

$$or$$

$$\frac{current performance of compute environment}{optimal performance of compute environment} ,$$

wherein each of the optimal performance of the target compute architecture (or the compute environment corresponding thereto) and the current performance of the target compute architecture (or the compute environment corresponding thereto) comprise a same unit of measurement (e.g., GB/s). For example, given that the current performance of the compute environment corresponding to the target compute architecture, in one or more embodiments, may be 4.2 GB/s and the compute environment corresponding to the optimal performance of the target compute architecture, in one or more embodiments, may be 5 GB/s, the performance efficacy metric (e.g., compute utilization value) of the compute environment (e.g., AI compute system) corresponding to the target compute architecture is 4.2/5=0.84.

### Explainability Artifacts and Recommendations Module

In one or more embodiments, the explainability artifacts and recommendations module 166 may function to generate and/or determine one or more explainability artifacts and one or more PoP improvement recommendations. PoP improvement recommendations generated for the target compute architecture (or the compute environment corresponding thereto) may relate to mitigating or reducing a performance bottleneck to increase overall performance of the target compute architecture. For instance, in a non-limiting example, the one or more PoP improvement recommendations generated for the compute environment corresponding to the target compute architecture may include load balancing over multiple compute nodes of the compute environment to reduce congestion, cleaning dust from cables of the compute environment corresponding to the target compute architecture to improve signal transmission, and/or optimizing routing within the compute environment corresponding to the target compute architecture to reduce latency, consequently improving the PoP score associated with the compute environment or the corresponding to the target compute architecture. Explainability artifacts and recommendations, as generally referred to herein, may include textual content, graphical content, and/or any other suitable visualization that provides intelligent insights into a configuration of the target compute architecture (or the compute environment corresponding thereto).

In one or more embodiments, the explainability artifacts and recommendations module 166 may function to generate and/or determine a corresponding percent improvement contribution metric in association with each of the one or more PoP improvement recommendations generated for the target compute architecture (or the compute environment corresponding thereto). The percent improvement contribution metric, in such embodiments, may inform the subscriber of a performance improvement effectiveness (or usefulness) of implementing such recommendation. The percent of improvement contribution may be quantitative (e.g., a numerical percentage) or may be qualitative (e.g., a descriptive effectiveness in improving performance, such as high, medium, and low).

In one or more embodiments, the explainability artifacts and recommendations module 166 may function to generate interactive graphics or other visualizations that illustrate the differences between the optimal performance of the target compute architecture (or the compute environment corresponding thereto) and the current performance of the target compute architecture (or the compute environment corresponding thereto). These interactive graphics or visualizations may include comparative graphics showing bandwidth capacities, latency information, processing speed data, and any other type of performance metric. At least one technical advantage of displaying this type of information may include allowing subscribers to intuitively understand the disparity between the optimal performance of the target compute architecture (or the compute environment corresponding thereto) and the current performance of the target compute architecture (or the compute environment corresponding thereto).

In one or more embodiments, the explainability artifacts and recommendations module 166 may function to generate textual content, graphical content, interactive graphics, or the like that emphasize the identified deviations between the optimal performance of the target compute architecture (or the compute environment corresponding thereto) and the current performance of the target compute architecture (or the compute environment corresponding thereto). Such textual content, graphical content, interactive graphics may be configured to illustrate one or more bottlenecks or performance degradation factors causing the deviations between the optimal performance of the target compute architecture (or the compute environment corresponding thereto) and the current performance of the target compute architecture (or the compute environment corresponding thereto), such as network congestion, misconfigured network settings, miswiring, dust on cables, etc. By surfacing these bottlenecks or performance degradation factors, the subscribers can intuitively understand why the current performance of their compute architecture (or the compute environment corresponding thereto) diverges from the optimal performance of their compute architecture (or the compute environment corresponding thereto).

In one or more embodiments, the explainability artifacts and recommendations module 166 may be in operable communication with the target compute architecture assessment and scoring interface 162. In one or more embodiments, at least one of the one or more explainability artifacts, the one or more PoP recommendations, the corresponding percent improvement contribution metrics, interactive graphics or visualizations, and textual and graphical content may be accessed by and displayed to the administrator and/or subscriber 168 via the GUI of the target compute architecture assessment and scoring interface module 162 or a GUI of a computing device, such as a computing device executing a software application in operable communication with the subsystem 160.

### 2.0 Method for Real-Time Assessment and Performance Optimization of Artificial Intelligence (AI) Compute Infrastructure

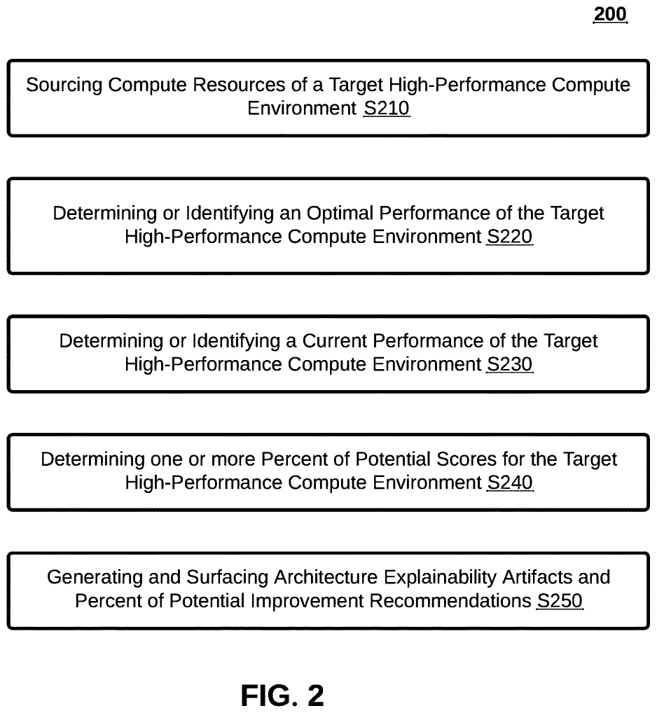

FIG. 2 illustrates a method 200 for assessing and scoring subscriber-implemented high-performance compute architectures (or otherwise referred to as target compute architectures herein). In one or more embodiments, a target compute architecture may relate to or correspond to a currently implemented real-world high-performance compute environment (e.g., AI data center, AI factory, data center, supercomputing center, telecommunication center, cloud computing center, etc.). The method 200, in one or more embodiments, may include sourcing compute resources associated with a target compute architecture S210, determining or identifying an optimal performance of the target compute architecture S220, determining or identifying a current performance of the target compute architecture S230, determining one or more PoP scores for the target compute architecture S240, and generating and surfacing architecture explainability artifacts and PoP improvement recommendations S250. It shall be noted that a system or service may implement at least a portion of the method 200 for assessing and scoring the target compute architecture.

In one or more embodiments, the method 200 for assessing and scoring a target high-performance compute architecture (or a high-performance compute environment that corresponds to the target compute architecture) may provide an administrator and/or subscriber with an understanding of a current performance of the target compute architecture (or the compute environment corresponding thereto) as currently configured and an optimal performance of the target compute architecture (or the compute environment corresponding thereto) as currently configured. In other words, the method 200 may help the administrator and/or subscriber intuitively understand the disparity between the optimal performance of the target compute architecture (or the compute environment corresponding thereto) and the current performance of the target compute architecture (or the compute environment corresponding thereto). The current performance of the target compute architecture may be understood as the current performance obtained by the target compute architecture (or the compute environment corresponding thereto) while the optimal performance of the target compute architecture may be understood as a maximum possible performance (or otherwise the best or most effective possible performance) that is obtainable by the target compute architecture (or the compute environment corresponding thereto) as currently configured. In one or more embodiments, the method 200 may further provide the administrator and/or subscriber with an understanding of one or more existing performance bottlenecks and an impact of each performance bottleneck on the overall performance of the target compute architecture. In one or embodiments, the method 200 may further provide the administrator and/or subscriber with recommendations for mitigating or reducing the one or more performance bottlenecks and the impact of implementing each of the recommendations on the overall performance of the target compute architecture. This may allow the administrator and/or subscriber to intuitively understand why the current performance of their compute architecture (or the compute environment corresponding thereto) diverges from the optimal performance of their compute architecture (or the compute environment corresponding thereto) and identify which performance bottlenecks to prioritize mitigating or reducing to improve the overall performance of the target compute architecture.

It shall be recognized that, in one or more embodiments, the systems, subsystems, and methods described herein may use one or more system components and/or one or more processes described in U.S. patent application Ser. No. 19/255,625, titled METHODS AND SYSTEMS FOR ENHANCED ASSESSMENT AND SCORING OF HIGH-PERFORMANCE COMPUTE ARCHITECTURES, which is incorporated herein in its entirety by this reference.

2.1 Sourcing Compute Resources Associated with the Target Compute Architecture

S210, which includes sourcing compute resources associated with the target compute architecture, may function to source, from the administrator and/or subscriber, the compute resources associated with the target compute architecture (or the compute environment corresponding thereto). The compute resources associated with the target compute architecture (or the compute environment corresponding thereto) may include, but are not limited to, existing compute nodes (e.g., CPUs, GPUs), network interconnects, network bandwidth specifications, memory configurations, and storage capacity. The existing compute nodes may indicate a total number of compute nodes within a compute environment that corresponds to the target compute architecture and a number of the compute nodes within the compute environment that are online. The compute resources may serve as input into a system or service implementing the method 200 to assess and score the target compute architecture (or the compute environment that corresponds to the target compute architecture). For instance, S210 may function to receive the compute resources associated with the target compute architecture (or the compute environment corresponding thereto), and, in turn, the system or service implementing method 200 may function to determine the one or more PoP scores of the target compute architecture (or the corresponding compute environment). It shall be recognized, in one or more embodiments, the administrator and/or subscriber may interface with at least a portion of the system or the service implementing the method 200 to specify or provide the compute resources associated with the target compute architecture (or the corresponding compute environment).

In one or more embodiments, S210 may function to autonomously source the compute resources associated with the target compute architecture (or the corresponding compute environment), and, in turn, the system or service implementing method 200 may function to determine the one or more PoP scores of the compute architecture (or the corresponding compute environment). S210, in one or more embodiments, may function to autonomously source the compute resources associated with the target compute architecture (or the corresponding compute environment) periodically (e.g., hourly, daily, weekly, bi-weekly, monthly, bi-monthly, bi-yearly, etc.). It shall be recognized, in one or more embodiments, the system or the service implementing method 200 may autonomously source the compute resources associated with the target compute architecture (or the compute environment (e.g., AI compute system) corresponding thereto) using any suitable method.

For instance, in a non-limiting example, a system or service implementing method 200 may function to automatically source, in real-time or near real-time, compute resources (e.g., compute resource data, compute infrastructure data) associated with a target compute environment (e.g., AI compute system, compute system, AI data center, data center, AI factory, or the like) using one or more application programming (API) interfaces, one or more API endpoints, orchestration services, cluster management tools, AI agents and/or the like.

Stated another way, in one or more embodiments, S210 may function to receive, via a computer network, a request to assess compute performance of an AI compute system that executes AI workloads for a subscribing entity. Accordingly, in one or more embodiments, in response to receiving the request, S210 may function to obtain, in real-time or near real-time, compute infrastructure data associated with the AI compute system. The compute infrastructure data, in such an embodiment, may include one or more of a corpus of compute node identifiers that includes a respective compute node identifier for each AI compute node of the AI compute system, node availability data indicating whether each AI compute node is online or offline, node-level hardware configuration data associated with each AI compute node, pod-level configuration data identifying groupings of AI compute nodes within the AI compute system, networking topology information describing interconnections between the AI compute nodes, firmware version information associated with one or more AI compute nodes, orchestration and workload scheduling parameters, historical performance metrics, real-time performance telemetry, and/or one or more architecture profile parameters corresponding to the AI compute system. For instance, in a non-limiting example, the compute infrastructure data may indicate that the AI compute system includes approximately 1,300 AI compute nodes interconnected via a high-speed InfiniBand fabric arranged in a multi-tier topology, wherein each AI compute node includes one or more CPUs, a plurality of GPUs interconnected via NVLink or similar high-bandwidth interconnect technology, local high-speed memory resources, and one or more network interface cards (NICs) configured to communicate over the InfiniBand fabric. In some embodiments, the compute infrastructure data may further specify link speeds (e.g., 200 Gbps or 400 Gbps InfiniBand links), switch-level configurations, fabric routing tables, GPU-to-GPU interconnect bandwidth values, and/or firmware versions associated with network interface controllers, switches, or GPUs.

An AI compute system, in one or more embodiments, may correspond to an AI factory or AI data center comprising a large-scale, physically deployed computing environment configured to execute artificial intelligence workloads, including distributed model training tasks, large-scale inference processing tasks, data preprocessing tasks, reinforcement learning workflows, and other parallelized compute-intensive operations. Such an AI factory or AI data center may include hundreds or thousands of AI compute nodes physically installed at a target geographic location (e.g., a physical location in the real-world) and interconnected via a high-speed networking fabric (e.g., an InfiniBand fabric arranged in a multi-tier leaf-spine topology). Each AI compute node, in one or more embodiments, may include one or more central processing units (CPUs), multiple graphics processing units (GPUs) interconnected via NVLink or similar high-bandwidth GPU-to-GPU interconnect technologies, high-speed memory resources, storage subsystems, and one or more network interface cards configured to communicate across the networking fabric.

An AI compute node, in some embodiments, may be operably configured to execute one or more AI workloads, including distributed training tasks, inference operations, model evaluation procedures, data transformation processes, and/or other parallelized compute-intensive functions. In such embodiments, each AI compute node may coordinate execution of workloads across its plurality of GPUs and may further communicate intermediate computation results, gradients, parameters, or synchronization signals with one or more other AI compute nodes via the networking fabric. Accordingly, compute performance associated with each AI compute node may depend on proper (e.g., optimal) operation of its CPUs, GPUs, memory resources, storage subsystems, network interface cards, associated firmware, and the integrity of physical interconnect components (e.g., cables, connectors, switch ports, and related hardware).

Stated another way, in one or more embodiments, the AI compute system may be configured to provide large-scale computational resources for training, deploying, and operating artificial intelligence models (e.g., machine learning models or the like) across a variety of application domains. For example, the AI factory or AI data center may be used to train large language models (LLMs), computer vision machine learning models, speech recognition machine learning models, recommendation systems, generative models, reinforcement learning agents, or other machine learning architectures that may require distributed execution across hundreds or thousands of GPUs. In some embodiments, the AI compute system may further support high-throughput inference processing for deployed AI models, batch data processing pipelines, model fine-tuning operations, hyperparameter optimization workflows, and/or simulation-based training environments. Because such AI workloads often involve parallelized computation distributed across multiple GPUs and multiple AI compute nodes, efficient operation of the AI compute system may require coordinated scheduling, synchronized gradient exchange, high-bandwidth inter-node communication, and consistent firmware and networking configurations across the infrastructure. As a result, performance of the AI factory may directly affect model training duration, inference latency, throughput of processed workloads, and overall operational efficiency of the subscribing entity.

Stated differently, the AI compute system may include any combination of hardware, software, firmware, or virtualized resources configured to execute instructions, process data, and/or provide network-based services. Such a compute environment (e.g., AI compute system) may include, without limitation, one or more processors, memory components, storage devices, operating systems, middleware, application programs, containers, virtual machines, cloud-based infrastructure, and associated communication interfaces. It shall be recognized that the term “compute environment” may be interchangeably referred to herein as an “AI compute system,” and such terms may be used synonymously unless expressly indicated otherwise.

For instance, in one or more embodiments, the AI compute system described herein may correspond to an AI data center constructed at a real-world geographic location. The AI data center, in such an embodiment, may include a plurality of distinct AI compute nodes in which each of the plurality of distinct AI compute nodes includes at least one or more central processing units, a plurality of graphics processing units, and memory. Furthermore, the AI data center may include networking hardware (e.g., InfiniBand cables, fiber optic cables, etc.) that physically couples the plurality of distinct AI compute nodes to enable data communication between the plurality of distinct AI compute nodes.

### 2.2 Determining or Identifying Optimal Performance of the Target Compute Architecture

S220, which includes determining or identifying the optimal performance of the target compute architecture, may function to determine or identify the optimal performance of the target compute architecture (or the optimal performance of the compute environment that corresponds to the target compute architecture). In one or more embodiments, the term optimal may be understood as the best or most effective possible. In one or more embodiments, the optimal performance of the target compute architecture may be understood as a maximum possible performance (or otherwise the best or most effective possible performance) that is obtainable by the target compute architecture (or the compute environment that corresponds to the target compute architecture) as currently configured. Stated another way, in some embodiments, the optimal performance of the AI compute system may correspond to the maximum compute performance obtainable or expected to be obtained by the AI compute system.

In one implementation, S220 may function to determine or identify the optimal performance of the target compute architecture (or the compute environment corresponding thereto) assuming a non-blocking network (e.g., no congestion). For instance, S220 may assume that the compute resources (e.g., hardware-type compute resources, software-type compute resources, etc.) associated with the target compute architecture (or the compute environment corresponding thereto) are operably configured to obtain maximum compute performance with no bottlenecks (e.g., hardware bottlenecks, software bottlenecks, etc.). In a second implementation, S220 may function to determine or identify the optimal performance of the target compute architecture (or the compute environment corresponding thereto) based on one or more expected (i.e., published) performance metrics associated with the target compute architecture or the compute environment corresponding thereto (e.g., the compute resources underpinning the compute environment corresponding to the target compute architecture as configured is expected to achieve a bandwidth capacity of 3.2 terabits per second, a processor interconnect latency of 100 nanoseconds, etc.). In such embodiments, S220 may function to search or lookup within a performance repository the one or more expected (i.e., published) performance metrics associated with the target compute architecture (or the compute environment corresponding thereto) and determine or identify the optimal performance of the target compute architecture (or the compute environment corresponding thereto). The one or more performance metrics may include, but are not limited to, bandwidth, job throughput, latency, FLOPS, processing speed, energy consumption rate, CPU/GPU utilization, input/out performance, etc.

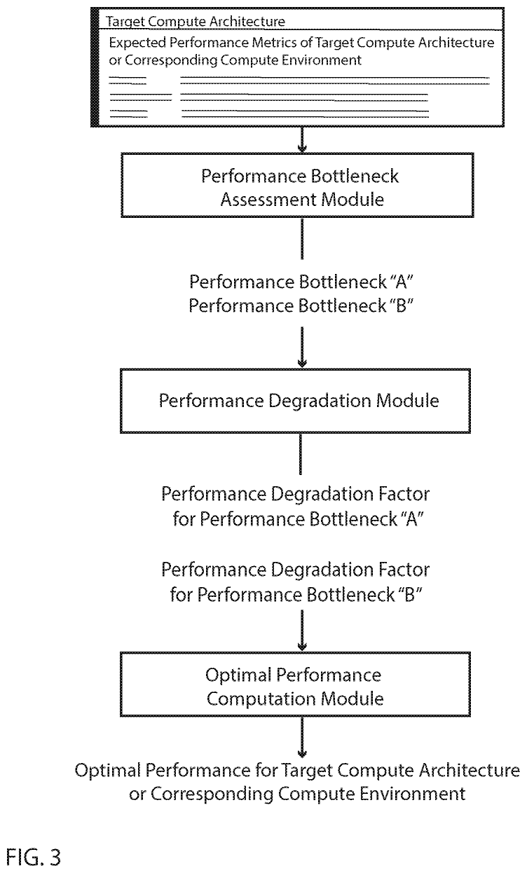

In a third implementation, S220 may function to determine or identify the optimal performance based on the target compute architecture (or the compute environment corresponding thereto) as currently configured. For instance, S220 may function to determine or identify the optimal performance of the target compute architecture (or the compute environment corresponding thereto) taking into consideration currently existing performance bottlenecks. In such embodiments, based on the compute resources associated with the target compute architecture (or the compute environment corresponding thereto), S230 may function to identify one or more performance bottlenecks within the target compute architecture (or the compute environment corresponding thereto). In one or more embodiments, S230 may function to search or lookup within a performance degradation repository or any other suitable data structure a performance degradation factor associated with each performance bottleneck. In such embodiments, S230 may function to apply a degradation factor associated with a performance bottleneck to the optimal performance of the target compute architecture (or the compute environment corresponding thereto) when operating without the performance bottleneck (e.g., the expected performance metrics associated with the target compute architecture (or the compute environment corresponding thereto) assuming no performance bottlenecks). For instance, an expected processor interconnect latency of the compute environment corresponding to the target compute architecture may be 100 nanoseconds assuming the corresponding compute environment is operating without performance bottlenecks. The target compute architecture assessment and scoring module 164 or the like may function to determine the optimal performance of the compute environment corresponding to the target compute architecture by applying a degradation factor associated with an identified performance bottleneck to the expected processor interconnect latency of 100 nanoseconds. In one or more embodiments, the performance degradation factor may be provided as a percentage or as a number between zero (0) to one (1). Where the performance degradation factor associated with a performance bottleneck is provided as a number between zero (0) to one (1), S230 may function to apply the performance degradation factor by, for example, multiplying the difference between one (1) and the degradation factor with the optimal performance of the target compute architecture (or the compute environment corresponding thereto) when operating without performance bottlenecks or, by multiplying the sum of one (1) and the degradation factor with the optimal performance of the target compute architecture (or the compute environment corresponding thereto) when operating without performance bottlenecks. Where the performance degradation factor is provided as a percentage, S230 may function to first divide the percentage by one hundred (100) to obtain a number between zero (0) and one (1). In a non-limiting example, the target compute architecture (or the compute environment corresponding thereto) may have a first performance bottleneck (e.g., congestion, misconfigured network settings, dust on cables, miswiring, etc.). Accordingly, S230 may function to search or lookup within a performance degradation repository or any other suitable data structure a performance degradation factor associated with the first performance bottleneck. S230 may function to identify that the first performance bottleneck is associated with a performance degradation factor of seventeen (17) percent based on searching the performance degradation repository. Accordingly, in such a non-limiting example, S230 may function to determine that the optimal performance of the target compute architecture (or the compute environment corresponding thereto) is seventeen (17) percent less than when operating without the first performance bottleneck. Given the compute environment corresponding to the target compute architecture has a processor interconnect latency of ninety (90) nanoseconds when operating without the first performance bottleneck, S230 may function to determine that the processor interconnect latency of the compute environment corresponding with the target compute architecture is 90×(1+(17/100))=105.3 nanoseconds when operating with the first performance bottleneck. Therefore, in this non-limiting example, the optimal performance of the processor interconnect latency of the compute environment corresponding to the target compute architecture as currently configured is determined to be 105.3 nanoseconds. Various approaches for applying the performance degradation factor may be used in different embodiments. FIG. 3 illustrates an example of determining an optimal performance of a target compute architecture (or the compute environment corresponding thereto) in accordance with one or more embodiments.

In one or more embodiments, S230 may function to receive, from the administrator and/or subscriber, optimal performance metrics associated with the target compute architecture (or the compute environment corresponding thereto). In one or more embodiments, S230 may function to determine or identify the optimal performance of the target compute architecture (or the compute environment corresponding thereto) based on the optimal performance metrics received. It shall be recognized, in one or more embodiments, the administrator and/or subscriber may interface with at least a portion of the system or the service implementing the method 200 to specify or provide the optimal performance metrics associated with the target compute architecture (or the compute environment corresponding thereto).

It shall be further noted that S230 may function to determine or identify the optimal performance of the target compute architecture (or the compute environment corresponding thereto) using different types of performance metrics, including but not limited to, latency, processing speed, energy consumption rate, FLOPS, job throughput, bandwidth, CPU/GPU utilization, and input/out performance, without departing from the full scope of the disclosure.

Additionally, or alternatively, in one or more embodiments, in response to obtaining the compute infrastructure data associated with the AI compute system, S220 may function to automatically compute, in real-time or near real-time, a maximum compute performance obtainable or expected to be obtained by the AI compute system. In some embodiments, the maximum compute performance may be determined based in part on hardware specifications, resource allocation parameters, virtualization overhead, thermal or power constraints, scheduling policies, and/or historical utilization data associated with the AI compute system. The computation of the maximum compute performance may further account for scaling configurations, including horizontal scaling across multiple nodes and/or vertical scaling within a given node, and may incorporate predictive modeling techniques to estimate performance under anticipated workload conditions. The maximum compute performance obtainable or expected to be obtained by the AI compute system may specify one or more upper-bound performance values associated with the AI compute system, including, but not limited to, a maximum achievable throughput value, a peak computational capacity value expressed in floating-point operations per second (FLOPS), a maximum bandwidth value, a maximum concurrent workload capacity, a maximum data processing rate value, and/or a maximum sustainable performance value over a defined time interval. In one or more embodiments, such maximum compute performance may be expressed as an absolute value, a range of values, a projected value under defined operating conditions, and/or a workload-specific performance metric.

For instance, in a non-limiting example, the compute infrastructure data may indicate that the AI compute system includes eight (8) AI compute nodes, each having a peak computational capacity of approximately three hundred twelve (312) teraFLOPS (e.g., FP16) and a memory bandwidth of approximately one and one-half (1.5) terabytes per second (TB/s). In such example, S220 may compute an upper-bound peak computational capacity of approximately two thousand four hundred ninety-six (2,496) teraFLOPS (i.e., 8×312 TFLOPS) and an upper-bound aggregate memory bandwidth of approximately twelve (12) TB/s (i.e., 8×1.5 TB/s). Additionally, or alternatively, the compute infrastructure data may indicate a network interconnect bandwidth (e.g., between AI compute nodes) of approximately four hundred (400) gigabits per second (Gb/s) per node; accordingly, S220 may compute an upper-bound aggregate interconnect bandwidth based on a number of nodes and/or a network topology specified by the compute infrastructure data.

### 2.3 Determining or Identifying Current Performance of the Target Compute Architecture

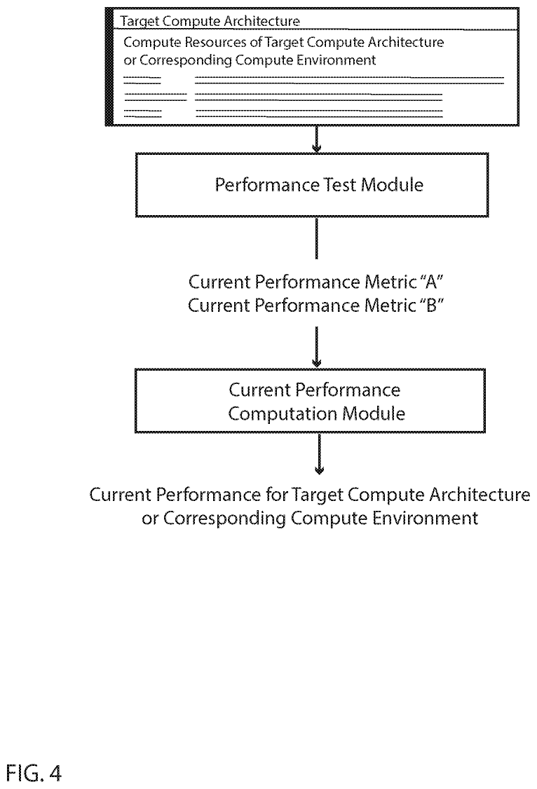

S230, which includes determining or identifying the current performance of the target compute architecture, may function to determine or identify the current performance of the target compute architecture or the compute environment that corresponds to the target compute architecture. In one or more embodiments, the current performance of the target compute architecture may be understood as the current performance obtained by the target compute architecture (or the compute environment that corresponds to the target compute architecture) as currently configured. In one or more embodiments, S230 may function to perform one or more performance tests on the compute environment corresponding to the target compute architecture and determine or identify the current performance of the target compute architecture (or the compute environment corresponding thereto) based on one or more performance metrics resulting from the one or more performance tests. For instance, in one or more embodiments, S230 may function to perform a NCCL all-reduce test on the compute environment corresponding to the target compute architecture. Accordingly, in such implementations, in response to executing the NCCL all-reduce test on the compute environment corresponding to the target compute architecture, the NCCL all-reduce test may output a throughput performance metric that indicates the amount of data processed per second, a latency performance metric that indicates the amount of time for the all-reduce operation to complete, and/or one or more scaling performance metrics that indicate the communication efficiency and computational workload distribution across multiple compute nodes of the compute environment corresponding to the target compute architecture. FIG. 4 illustrates an example of determining a current performance of a target compute architecture in accordance with one or more embodiments.

It shall be recognized that, in one or more embodiments, S230 may function to execute any suitable standardized test that measures the current performance of the compute environment corresponding to the target compute architecture. For example, in one or more embodiments, S230 may function to perform one or more subscriber-specific performance tests on the compute environment corresponding to the target compute architecture, from which one or more performance metrics are obtained.

In one or more embodiments, S230 may function to source current performance metrics associated with the target compute architecture (or the compute environment that corresponds to the target compute architecture) from a separate software or system executing one or more suitable performance tests. In one or more embodiments, S230 may function to determine or identify the current performance of the target compute architecture (or the compute environment corresponding thereto) based on the current performance metrics associated with the target compute architecture (or the compute environment corresponding thereto) received from the separate software or system executing the suitable performance test. It shall be noted that the current performance of the compute environment corresponding to the target compute architecture may be measured using any suitable performance test.

In one or more embodiments, S230 may function to perform one or more subscriber-specific performance tests on the compute environment corresponding to the target compute architecture. S230 may function to determine or identify the current performance of the target compute architecture (or the compute environment corresponding thereto) based on one or more performance metrics measured during the one or more subscriber-specific performance tests. In one or more embodiments, S230 may function to receive, from the administrator and/or subscriber, current performance metrics associated with the target compute architecture (or the compute environment corresponding thereto). In one or more embodiments, S230 may function to determine or identify the current performance of the target compute architecture (or the compute environment corresponding thereto) based on the current performance metrics associated with the target compute architecture (or the compute environment corresponding thereto) received. It shall be recognized, in one or more embodiments, the administrator and/or subscriber may interface with at least a portion of the system or the service implementing the method 200 to specify or provide the current performance metrics associated with the target compute architecture (or the compute environment corresponding thereto).

It shall be noted that S230 may function to determine or identify the current performance of the target compute architecture (or the compute environment corresponding thereto) based on different types of performance metrics associated with the target compute architecture (or the compute environment corresponding thereto), including but not limited to, latency, processing speed, energy consumption rate, FLOPS, job throughput, bandwidth, CPU/GPU utilization, and input/out performance, without departing from the full scope of the disclosure.

Additionally, or alternatively, in one or more embodiments, in response to obtaining the compute infrastructure data associated with the AI compute system, S230 may function to execute, in real-time or near real-time, one or more compute performance tests (e.g., NCCL all-reduce test, etc.) on the AI compute system to determine a current compute performance of the AI compute system. Stated another way, S230 may assess the AI compute system by invoking one or more diagnostic, stress-testing, or workload-simulating computer routines configured to measure actual operational performance under present system conditions. In some embodiments, the one or more compute performance tests may be configured to measure one or more performance characteristics including, without limitation, inter-device communication bandwidth, latency, synchronization efficiency, floating-point operation throughput (FLOPS), memory bandwidth utilization, storage input/output performance, and/or end-to-end workload execution time. The current compute performance determined by S230 may therefore represent an empirically measured performance profile of the AI compute system at a given time, reflecting real-world operating conditions including resource contention, background workloads, thermal conditions, and/or network constraints.

For instance, in a non-limiting example, in response to executing the one or more compute performance tests on the AI compute system, the one or more compute performance tests may output results that specify one or more measured performance values associated with the AI compute system, including, without limitation, a measured aggregate inter-device communication bandwidth value, a measured latency value, a measured floating-point operation throughput value expressed in FLOPS, a measured memory bandwidth utilization value, a measured storage input/output rate value, and/or a measured end-to-end workload execution time value.

Stated differently, in one or more embodiments, a maximum compute performance value computed for the AI compute system may represent an upper-bound or theoretically obtainable performance capacity derived from compute infrastructure data, whereas the current compute performance of the AI compute system represents a represents a real-world, empirically measured operational performance of the AI compute system under current runtime conditions.

Additionally, or alternatively, in one or more embodiments, in response to obtaining the compute infrastructure data associated with the AI compute system, S230 may function to automatically execute, in real-time or near real-time, an automated node health assessment based on providing the corpus of compute node identifiers to a node health computer program. A node health computer program, as generally referred to herein, may comprise one or more executable routines configured to query, monitor, and/or analyze operational status information associated with each compute node (e.g., AI compute node or the like) of the AI compute system. For instance, in some embodiments, the node health computer program may collect and evaluate one or more node-level health indicators including, without limitation, processor utilization metrics, accelerator status indicators, memory usage statistics, storage health parameters, network interface status, error logs, temperature readings, power consumption metrics, firmware versions, driver states, and/or hardware fault codes. Based on such collected information, the node health computer program may determine a node health status for each AI compute node, such as healthy, degraded, impaired, offline, or otherwise unavailable, and may generate one or more health assessment outputs indicative of an overall system health condition.

Stated another way, in one or more embodiments, executing the automated node health assessment enables S230 to determine a total number of AI compute nodes (e.g., compute nodes or the like) online in the AI compute system, a total number of AI compute nodes offline in the AI compute system, and/or a total number of AI compute nodes included in the AI compute system.

It shall be recognized that, in one or more embodiments, a compute node (e.g., AI compute node or the like) may be considered “online” when the compute node is powered on, communicatively accessible over one or more network interfaces, responsive to health-check queries and/or control-plane communications, and capable of executing one or more computational workloads. In some embodiments, an online compute node may further satisfy one or more operational readiness criteria, such as having required drivers loaded, accelerators initialized, storage mounted, and/or required software services actively running. Stated another way, an online compute node may be a compute node that is both reachable and operationally available for participation in one or more distributed computing tasks of the AI compute system.

It shall be further recognized that, in one or more embodiments, a compute node (e.g., AI compute node or the like) may be considered “offline” when the compute node is not communicatively accessible to one or more control-plane components of the AI compute system, fails to respond to one or more health-check or heartbeat signals within a predefined time interval, is powered down, has experienced a hardware or software fault, has been administratively disabled, and/or is otherwise unavailable to execute one or more computational workloads. In some embodiments, an offline designation may be automatically assigned to a respective compute node based on failure to satisfy one or more predefined availability or operational readiness criteria. Stated another way, an offline compute node may be a compute node that is either unreachable by the AI compute system or not presently capable of participating in one or more distributed computing operations of the AI compute system.

Additionally, or alternatively, in one or more embodiments, the system or service implementing method 200 may automatically compute the maximum compute performance obtainable by the AI compute system by at least (i) identifying, based on the compute infrastructure data associated with the AI compute system, a respective compute architecture profile corresponding to the AI compute system and (ii) retrieving, from a compute performance repository, a reference maximum compute performance value associated with the respective compute architecture profile based on querying the compute performance repository using the respective compute architecture profile as a search parameter. It shall be recognized that, in some embodiments, the maximum compute performance obtainable by the AI compute system may correspond to the reference maximum compute performance value associated with the respective compute architecture profile. Stated differently, in some embodiments, the system or service implementing method 200 may determine the maximum compute performance obtainable by the AI compute system by referencing historical or benchmarked compute performance values associated with AI compute systems having compute architectures corresponding to the respective compute architecture profile. In such embodiments, the retrieved reference maximum compute performance value may represent an expected upper-bound compute performance achievable by the AI compute system under optimal operating conditions for the respective compute architecture profile.

### 2.4 Determining PoP Scores of the Target Compute Architecture

S240, which includes determining the PoP score for the target compute architecture, may function to determine the PoP score for the target compute architecture (or the compute environment corresponding thereto). The PoP score, as generally referred to herein, may be a quantitative measure that indicates a disparity between a current performance of the target compute architecture (or the compute environment that corresponds to the target compute architecture) and the optimal performance of the target compute architecture (or the compute environment that corresponds to the target compute architecture). It shall be recognized that the PoP score of the target compute architecture (or the compute environment corresponding thereto) may fall between any two values (e.g., 0-100), a set of alphanumeric characters (e.g., A-Z), or any range of non-numerical indicators (e.g., color gradations like green to yellow to red, or descriptive levels like low to intermediate to high, etc.).

In one or more embodiments, based on the compute resources associated with the target compute architecture (or the compute environment corresponding thereto), S240 may function to determine a compute node availability efficacy metric of the target compute architecture (or the compute environment that corresponds to the target compute architecture). In one or more embodiments, S240 may function to determine the node availability efficacy metric as the ratio

$$\frac{the number of compute nodes online}{the total number of compute nodes} .$$

For instance, in a first non-limiting example, S240 may determine the node availability efficacy metric of the compute environment corresponding to the target compute architecture is 0.7 based on the compute resources indicating 70 compute nodes online within the compute environment corresponding to the target compute architecture and 100 total compute nodes within the compute environment corresponding to the target compute architecture

$$( e . g . , \frac{70}{100} = 0.7 ) .$$

In a second non-limiting example, S240 may determine the node availability efficacy metric of the compute environment corresponding to the target compute architecture is 0.82 based on the compute resources indicating 196 compute nodes online within the compute environment corresponding to the target compute architecture and 240 total compute nodes within the compute environment corresponding to the target compute architecture

$$( e . g . , \frac{196}{240} = 0.82 ) .$$

In one or more embodiments, S240 may function to determine a performance efficacy metric of the target compute architecture (or the compute environment corresponding thereto) based on the current performance of the target compute architecture (or the compute environment that corresponds to the target compute architecture) and the optimal performance of the target compute architecture (or the compute environment that corresponds to the target compute architecture). In one or more embodiments, S240 may function to determine the performance efficacy metric as the ratio of

$$\frac{current performance of target compute architecture}{optimal performance of target compute architecture}$$

$$or$$

$$\frac{current performance of compute environment}{optimal performance of compute environment} ,$$

wherein each of the optimal performance of the target compute architecture or the compute environment corresponding thereto and the current performance of the target compute architecture or the compute environment corresponding thereto, respectively, comprise a same unit of measurement. For instance, in a non-limiting example, S240 may determine or identify that the optimal performance of the compute environment corresponding to the target compute architecture achieves a bandwidth capacity of 192 gigabits per second and the current performance of the compute environment corresponding to the target compute architecture achieves a bandwidth capacity of 70 gigabits per second. As such, S240 may determine the performance efficacy of the compute environment corresponding to the target compute architecture is

$$0.36 ( e . g . , \frac{70 gigabits per second}{192 gigabits per second} = 0.36 ) .$$

In a second non-limiting example, S240 may determine or identify that the optimal performance of the compute environment corresponding to the target compute architecture achieves 50 teraflops and the current performance of the compute environment corresponding to the target compute architecture achieves 39 teraflops. As such, S240 may determine the performance efficacy of the compute environment corresponding to the target compute architecture is

$$0.78 ( e . g . , \frac{39 teraflops}{50 teraflops} = 0.78 ) .$$

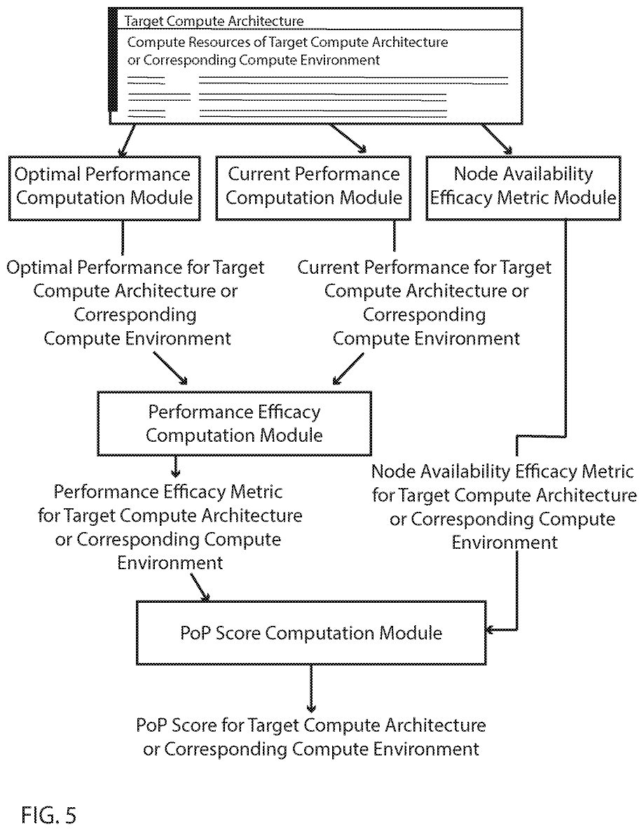

In one or more embodiments, S240 may function to determine the PoP score of the target compute architecture (or the compute environment corresponding thereto). In one or more embodiments, S240 may function to determine the PoP score as the product of the compute node availability efficacy metric and the performance efficacy metric PoP=(i.e., the compute node availability efficacy metric of the target compute architecture×the performance efficacy metric of the target compute architecture; or PoP=the compute node availability efficacy metric of the compute environment×the performance efficacy metric of the compute environment). For instance, in a non-limiting example, S240 may determine the PoP score of the target compute architecture is 0.25 given the performance efficacy of the target compute architecture is 0.36 and the node availability efficacy is 0.7 (e.g., 0.36×0.7=0.25). In some embodiments, the PoP score may be reported as a percentage. For instance, in this non-limiting example, the PoP score may be reported as 25 percent. In a second non-limiting example, S240 may determine the PoP score of the target compute architecture is 0.64 given the performance efficacy of the target compute architecture is 0.78 and the node availability efficacy is 0.82 (e.g., 0.78×0.82=0.64). In some embodiments, the PoP score may be reported as 64 percent. The PoP score may indicate a disparity between the current performance of the target compute architecture (or the compute environment that corresponds to the target compute architecture) and the optimal performance of the target compute architecture (or the compute environment that corresponds to the target compute architecture). FIG. 5 illustrates an example of determining a PoP score for a target compute architecture in accordance with one or more embodiments.

In some embodiments, S240 may function to compute two or more PoP scores (e.g., two or more PoP scores, three or more PoP scores, four or more PoP scores, five or more PoP scores, etc.) for the target compute architecture (or the compute environment corresponding thereto). In such embodiments, the performance efficacy metric used in determining each PoP score may be determined using a different performance metric (e.g., bandwidth, latency, processing speed, FLOPS, energy consumption rate, job throughput, CPU/GPU utilization, input/out performance, etc.). Accordingly, S240 may function to compute a distinct PoP score for each different performance metric. For example, S240 may function to compute a first distinct PoP score for the target compute architecture (or the compute environment corresponding thereto) based on using bandwidth to determine the performance efficacy metric and a second distinct PoP score for the target compute architecture (or the compute environment corresponding thereto) based on using latency to determine the performance efficacy metric.

Additionally, or alternatively, in embodiments in which multiple PoP scores are determined for the target compute architecture (or the compute environment corresponding thereto), S240 may function to determine a composite PoP score based on the multiple PoP scores determined for the target compute architecture (or the compute environment corresponding thereto). For instance, the composite PoP score determined for the target compute architecture (or the compute environment corresponding thereto) may be an averaged PoP score (e.g., summing the multiple PoP scores and dividing the sum of PoP scores by the total number of PoP scores determined) or a weighted average (e.g., multiplying each distinct PoP score by its respective weight and dividing the total by the sum of the weights, wherein each distinct PoP score of the multiple PoP scores may be assigned a specific weight based on its relevance or impact).

Additionally, or alternatively, in one or more embodiments, S240 may function to compute, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system. The percent of potential value computed for the AI compute system, in such an embodiment, may indicate a degree to which the AI compute system is operating below the maximum compute performance obtainable by the AI compute system.

In one or more embodiments, in response to computing the percent of potential value for the AI compute system, the system or service implementing method 200 may function to automatically generate, in real-time or near real-time, one or more explainability artifacts that graphically identify one or more AI compute nodes or one or more pods within the AI compute system that cause the AI compute system to operate below the maximum compute performance. Accordingly, in such an embodiment, the system or service may display, using a graphical user interface or the like, the percent of potential value computed for the AI compute system in association with the one or more explainability artifacts.

Stated another way, in some embodiments, the percent of potential value may represent a normalized compute performance indicator that reflects both (i) a proportion of AI compute nodes that are online relative to a total number of AI compute nodes included in the AI compute system and (ii) a ratio of the current compute performance to the maximum compute performance obtainable by the AI compute system. In this manner, the percent of potential value may provide a unified metric indicative of an overall operational efficiency of the AI compute system. In one or more embodiments, the percent of potential value may be computed based on a function that combines (a) a node availability ratio (e.g., number of online nodes divided by total nodes) and (b) a performance utilization ratio (e.g., current compute performance divided by maximum compute performance). As such, the percent of potential value may decrease when one or more compute nodes are offline and/or when measured runtime performance deviates from theoretical upper-bound performance values. Accordingly, the percent of potential value may enable operators, administrators, or automated orchestration services to quickly assess an extent to which the AI compute system is underperforming relative to its full compute capacity, and to identify whether such underperformance is attributable primarily to node availability limitations, performance degradation, interconnect bottlenecks, workload imbalance, or combinations thereof.

In one or more embodiments, computing the percent of potential value for the AI compute system may include (i) computing an AI node availability value of the AI compute system based on a ratio between the total number of AI compute nodes online in the AI compute system and the total number of AI compute nodes included in the AI compute system, (ii) computing a compute utilization value of the AI compute system based on a ratio between the current compute performance of the AI compute system and the maximum compute performance obtainable by the AI compute system, and (iii) computing the percent of potential value for the AI compute system based on a product of the AI node availability value and the compute utilization value.

For instance, in a non-limiting example, the maximum compute performance obtainable by the AI compute system may include a maximum bandwidth capacity obtainable or expected by the AI compute system, and the current compute performance of the AI compute system may include a current bandwidth capacity of the AI compute system. In such a non-limiting example, the system or service implementing method 200 may function to compute the percent of potential value for the AI compute system by at least (i) computing an AI node availability value of the AI compute system based on a ratio between the total number of AI compute nodes online in the AI compute system and the total number of AI compute nodes included in the AI compute system, (ii) computing a bandwidth efficacy value of the AI compute system based on a ratio between the current bandwidth capacity of the AI compute system and the maximum bandwidth capacity obtainable by the AI compute system, and (iii) computing the percent of potential value for the AI compute system based on a product of the AI node availability value and the bandwidth efficacy value.

In another non-limiting example, the maximum compute performance obtainable the AI compute system may include a maximum parallel floating-point operations per second (FLOPS) value expected by the AI compute system, and the current compute performance of the AI compute system includes a current parallel FLOPS value measured for the AI compute system. In such a non-limiting example, the system or service implementing method 200 may function to compute the percent of potential value for the AI compute system by at least (i) computing an AI node availability value of the AI compute system based on a ratio between the total number of AI compute nodes online in the AI compute system and the total number of AI compute nodes included in the AI compute system, (ii) computing a FLOPS efficacy value of the AI compute system based on a ratio between the current parallel FLOPS value measured for the AI compute system and the maximum FLOPS value expected by the AI compute system, and (iii) computing the percent of potential value for the AI compute system based on a product of the AI node availability value and the FLOPS efficacy value.

### 2.5 Generating and Surfacing Explainability Artifacts and Recommendations

S250, which includes generating and surfacing compute architecture explainability artifacts and recommendations, may function to generate and surface, via one or more computers, one or more explainability artifacts and one or more PoP improvement recommendations to the subscriber (e.g., subscribing entity). Explainability artifacts and recommendations, as generally referred to herein, may include textual content, graphical content, and/or any other suitable visualization that provides intelligent insights into a configuration of the target compute architecture.

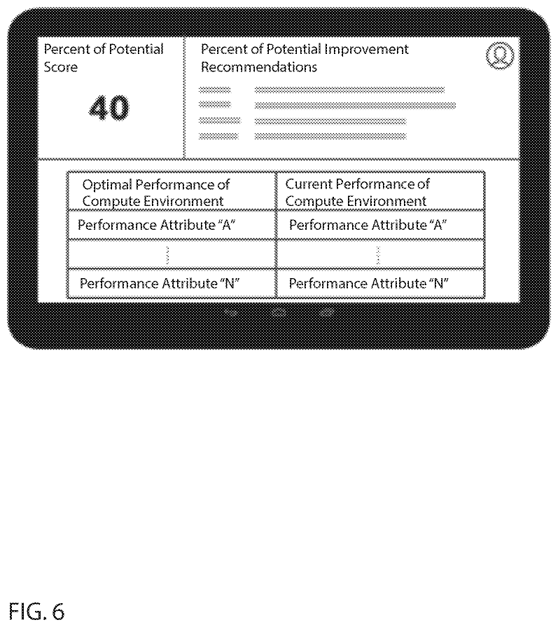

In one or more embodiments, based on receiving the compute resources, the system or service implementing method 200 may function to determine the PoP score for the target compute architecture (or the compute environment corresponding thereto) in analogous ways as described above. Furthermore, in such embodiments, the system or service implementing method 200 may function to display the determined PoP score for the target compute architecture (or the compute environment corresponding thereto) on a GUI that is accessible by the subscriber, as shown generally by way of example in FIG. 6.

Additionally, or alternatively, in one or more embodiments, S250 may function to generate one or more PoP improvement recommendations for the target compute architecture (or the compute environment corresponding thereto). In such embodiments, each of the one or more PoP improvement recommendations generated for the target compute architecture (or the compute environment corresponding thereto) may relate to mitigating or reducing a performance bottleneck to increase overall performance of the target compute architecture (or the compute environment corresponding thereto). Stated in another way, in one or more embodiments, each of the one or more PoP improvement recommendations, if implemented, may increase the PoP score associated with the target compute architecture (or the compute environment corresponding thereto). For instance, in a non-limiting example, one of the one or more PoP improvement recommendations generated for the compute environment corresponding to the target compute architecture may include load balancing over multiple compute nodes of the compute environment to reduce congestion, and consequently, improve the PoP score associated with the compute environment corresponding to the target compute architecture. In another non-limiting example, one of the one or more PoP improvement recommendations generated for the compute environment corresponding to the target compute architecture may include cleaning dust from cables of the compute environment to improve signal transmission, and consequently, the PoP score associated with the compute environment corresponding to the target compute architecture. In another non-limiting example, one of the one or more PoP improvement recommendations generated for the compute environment corresponding to the target compute architecture may include optimizing routing within the compute environment to reduce latency, and consequently, improve the PoP score associated with the compute environment corresponding to the target compute architecture.

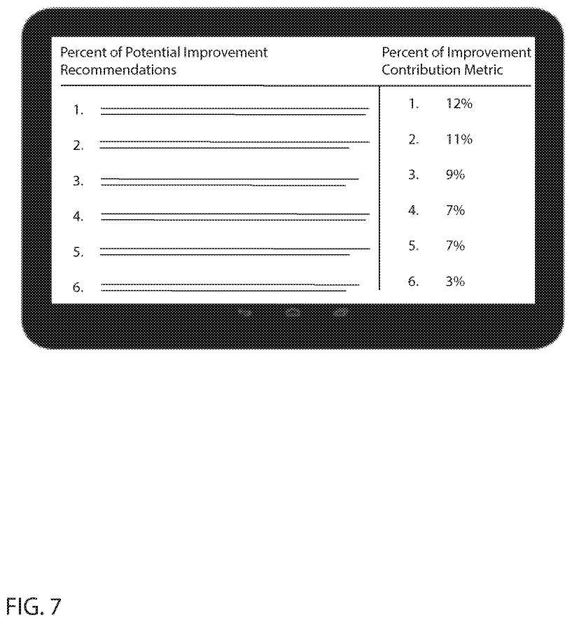

Additionally, or alternatively, in one or more embodiments, S250 may function to display each of the one or more PoP improvement recommendations generated for the target compute architecture (or the compute environment corresponding thereto) on the graphical user interface, as shown generally by way of example in FIG. 6. Furthermore, in some embodiments, S250 may function to display a corresponding percent improvement contribution metric in association with each of the one or more PoP improvement recommendations generated for the target compute architecture (or the compute environment corresponding thereto), as shown generally by way of example in FIG. 7. The percent improvement contribution metric, in such embodiments, may inform the subscriber of a performance improvement effectiveness (or usefulness) of implementing such recommendation. Stated differently, the percent improvement contribution metric may inform the subscriber of the performance benefit or performance impact value of implementing a corresponding proposed PoP improvement recommendation. The percent of improvement contribution may be quantitative (e.g., a numerical percentage) or may be qualitative (e.g., a descriptive effectiveness in improving performance, such as high, medium, and low).

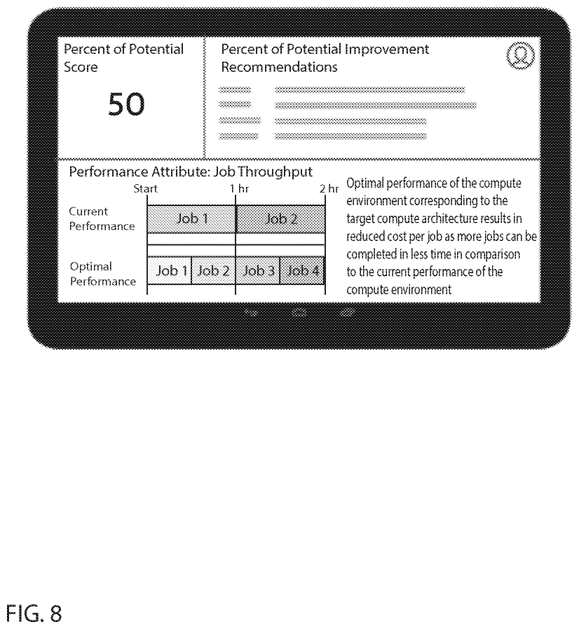

Additionally, or alternatively, in one or more embodiments, S250 may function to generate and display, via the graphical user interface, interactive graphics or other visualizations that illustrate the differences between the optimal performance of the target compute architecture (or the compute environment that corresponds to the target compute architecture) and the current performance of the target compute architecture (or the compute environment that corresponds to the target compute architecture). These interactive graphics or visualizations may include comparative graphics showing bandwidth capacities, latency information, processing speed data, and any other type of performance metric. FIG. 8 in particular illustrates comparative graphics of a current job throughput performance of the compute environment corresponding to the target compute architecture and an optimal job throughput performance of the compute environment corresponding to the target compute architecture. Achieving optimal job throughput performance of the compute environment corresponding to the target compute architecture results in reduced cost per job as more jobs can be completed in less time in comparison to the current job throughput performance of the compute environment corresponding to the target compute architecture. For example, the cost per job with the optimal job throughput performance may be $4.50 while the cost per job with the current job throughput performance may be $5.00. At least one technical advantage of displaying this type of information may include allowing subscribers to intuitively understand the disparity between the optimal performance of the target compute architecture (or the compute environment corresponding thereto) and the current performance of the target compute architecture (or the compute environment corresponding thereto).

Stated another way, in one or more embodiments, the current compute performance of the AI compute system may specify a current job throughput performance of the AI compute system and, in turn, the system or service implementing method 200 may function to compute, based in part on the current job throughput performance of the AI compute system, a first time duration required to complete a target set of AI workloads. Furthermore, in such an embodiment, the system or service implementing method 200 may function to compute, using one or more processors, a projected job throughput performance of the AI compute system expected from implementation of the one or more percent of potential improvement recommendations within the AI compute system and, in response, compute, based in part on the projected job throughput performance of the AI compute system, a second time duration required to complete the target set of AI workloads. Accordingly, in such an embodiment, the system or service implementing method 200 may function to generate a comparative throughput artifact that graphically depicts (i) the target set of AI workloads completed in the first time duration based on the current job throughput performance of the AI compute system and (ii) the target set of AI workloads completed in the second time duration based on the projected job throughput performance of the AI compute system, as shown generally by way of example in FIG. 8. Furthermore, the system or service implementing method 200 may function to display, via a graphical user interface, the comparative throughput artifact in association with the percent of potential value computed for the AI compute system and the one or more percent of potential improvement recommendations.

Additionally, or alternatively, in one or more embodiments, S250 may function to generate and display, via the graphical user interface, textual content, graphical content, interactive graphics, or the like that emphasize the identified deviations between the optimal performance of the target compute architecture (or the compute environment corresponding thereto) and the current performance of the target compute architecture (or the compute environment corresponding thereto). Such textual content, graphical content, interactive graphics may be configured to illustrate one or more bottlenecks causing the deviations between the optimal performance of the target compute architecture (or the compute environment corresponding thereto) and the current performance of the target compute architecture (or the compute environment corresponding thereto), such as network congestion, misconfigured network settings, miswiring, dust on cables, etc. By surfacing these bottlenecks, the subscribers can intuitively understand why the current performance of their compute architecture (or the compute environment corresponding thereto) diverges from the optimal performance of their compute architecture (or the compute environment corresponding thereto).

In one or more embodiments, the system or service implementing method 200 may function to generate and surface one or more user interface objects that graphically illustrate a performance of a respective compute environment. Such user interface objects (e.g., compute environment explainability artifacts or the like), in one or more embodiments, may provide explainability to the PoP score computed for the respective compute environment, visually emphasize components of the respective compute environment that are performing optimally, and/or visually emphasize components of the respective compute environment that are underperforming or contributing to inefficiencies. This may enable users to intuitively identify components (e.g., hardware components, software components, etc.) within the respective compute environment that requires remediation or optimization to improve the PoP score and, in turn, increase the overall performance of the respective compute environment.

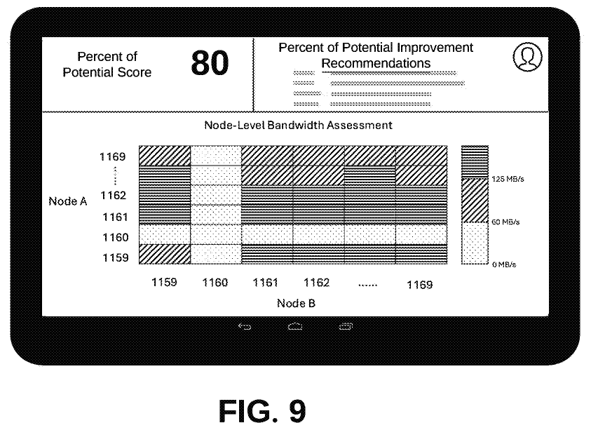

For instance, in a non-limiting example, the system or service implementing method 200 may function to compute a PoP score for a respective compute environment and generate a node-level bandwidth assessment artifact for the respective compute environment. Accordingly, in such a non-limiting example, the computed PoP score and the node-level bandwidth assessment artifact for the respective compute environment may be surfaced to a user associated with the respective compute environment using a graphical user interface, as shown generally by way of example in FIG. 9.

The node-level bandwidth assessment artifact, in one or more embodiments, may include a visual representation of bandwidth performance between compute nodes within the respective compute environment. The node-level bandwidth assessment artifact may take the form of a heatmap, matrix, or any other suitable type of graphical visualization where pairwise bandwidth metrics between nodes are depicted, as shown generally by way of example in FIG. 9. Such node-level bandwidth assessment artifact may enable users to identify node bottlenecks and/or node inefficiencies within the respective compute environment.

In a non-limiting example, the node-level bandwidth assessment artifact may include a color legend or color scale that maps specific colors to corresponding bandwidth values. For instance, the color legend may range from a first color (e.g., green) representing the highest bandwidth values to a second color (e.g., yellow) representing moderate bandwidth values, and a third color (e.g., black) representing the lowest bandwidth values. For example, the first color may correspond to bandwidth values exceeding 125 MB/s, while the second color may represent bandwidth values between 60 MB/s and 125 MB/s, and the third color may indicate bandwidth values below 60 MB/s. The color legend or color scale may provide an intuitive means of interpreting the bandwidth metrics displayed in the node-level bandwidth assessment artifact.

Accordingly, in one or more embodiments, the system or service may function to generate the node-level bandwidth assessment artifact for the respective compute environment and display the generated node-level bandwidth assessment artifact in association with the PoP score computed for the respective compute environment on a graphical user interface, as shown generally by way of example in FIG. 9. In such an embodiment, the PoP score computed for the respective compute environment may be eighty (80) and the node-level bandwidth assessment artifact may visually emphasize that all nodes except the node titled “1160,” are operating within acceptable bandwidth ranges. The graphical representation within the node-level bandwidth assessment artifact may highlight node “1160” through a distinct color coding (e.g., black or the like) to indicate that node “1160” has lower bandwidth values compared to other nodes within the respective compute environment. This visual emphasis may allow users to quickly identify node “1160” as a potential bottleneck or point of inefficiency in the respective compute environment and that node “1159”, “1161”, “1162”, “1163”, “1164”, “1165”, “1166”, “1167”, “1168”, and “1169” are all operating within acceptable bandwidth ranges. In one or more embodiments, to improve the PoP score computed for the respective compute environment, a user may address the bandwidth performance issue associated with node “1160” by resolving any hardware or network-related inefficiencies impacting the bandwidth associated with node “1160.”

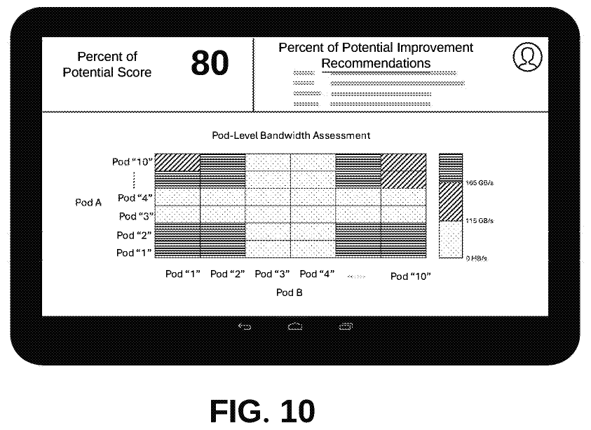

Additionally, or alternatively, in another non-limiting example, the system or service implementing method 200 may function to compute a PoP score for the respective compute environment and generate a pod-level bandwidth assessment artifact for the respective compute environment. Accordingly, in such a non-limiting example, the computed PoP score and the generated pod-level bandwidth assessment artifact for the respective compute environment may be surfaced to a user associated with the respective compute environment using a graphical user interface, as shown generally by way of example in FIG. 10. A pod, as generally referred to herein, may be a collection of a plurality of nodes (e.g., 16 nodes, 32 nodes) grouped together to function as a computational unit within the respective compute environment.

In a non-limiting example, the pod-level bandwidth assessment artifact may include a color legend or color scale that maps specific colors to corresponding bandwidth values. For instance, the color legend may range from a first color (e.g., green) representing the highest bandwidth values to a second color (e.g., yellow) representing moderate bandwidth values, and a third color (e.g., black) representing the lowest bandwidth values. For example, the first color may correspond to bandwidth values exceeding 165 GB/s, while the second color may represent bandwidth values between 115 GB/s and 165 GB/s, and the third color may indicate bandwidth values below 115 GB/s. The color legend or color scale may provide a clear and intuitive means of interpreting the bandwidth metrics displayed in the pod-level bandwidth assessment artifact.

Accordingly, in one or more embodiments, the system or service may function to generate the pod-level bandwidth assessment artifact for the respective compute environment and display the generated pod-level bandwidth assessment artifact in association with the PoP score computed for the respective compute environment on a graphical user interface, as shown generally by way of example in FIG. 10. In such an embodiment, the PoP score computed for the respective compute environment may be eighty (80) and the pod-level bandwidth assessment artifact may visually emphasize that pod “3” and pod “4” are not operating within acceptable bandwidth ranges. The graphical representation within the pod-level bandwidth assessment artifact may highlight or emphasize pod “3” and pod “4” through a distinct color coding (e.g., black or the like) to indicate that pod “3” and pod “4” have lower bandwidth values compared to other pods within the respective compute environment. This visual emphasis may allow users to quickly identify pod “3” and pod “4” as a potential bottleneck or point of inefficiency in the respective compute environment. Thus, to improve the PoP score computed for the respective compute environment, a user may address the bandwidth performance issue associated with pod “3” and pod “4” by resolving any hardware or network-related inefficiencies impacting the bandwidth associated with pod “3” and pod “4.”

It shall be recognized that, in one or more embodiments, the pod-level bandwidth assessment artifact may provide a high-level overview of performance between groups of nodes (pods), enabling users to quickly identify a problematic pod that exhibits lower performance compared to others pods within the respective compute environment. Once a problematic pod has been identified within the respective compute environment, the system or service may allow users to drill down into the node-level bandwidth assessment artifact to pinpoint the specific node or nodes within the problematic pod contributing to the performance issue.

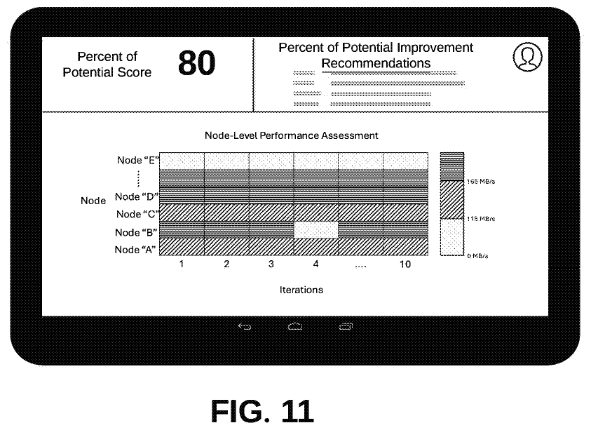

Additionally, or alternatively, in another non-limiting example, the system or service implementing method 200 may function to compute a PoP score for the respective compute environment and generate a node-level performance assessment artifact for the respective compute environment. Accordingly, in such a non-limiting example, the computed PoP score and the generated node-level performance assessment artifact for the respective compute environment may be surfaced to a user associated with the respective compute environment using a graphical user interface, as shown generally by way of example in FIG. 11.

The node-level performance assessment artifact, in one or more embodiments, may include a heatmap or matrix visualization where performance run iterations may be represented on the x-axis (showing time or sequential steps), and individual nodes of the respective compute environment may be represented on the y-axis. Each cell in the heatmap or matrix may correspond to the bandwidth performance of a specific node during a particular iteration, with colors indicating bandwidth values as defined by the corresponding color scale. Such temporal representation may enable users to observe bandwidth trends for individual nodes over time, highlighting consistent performance, fluctuations, or anomalies.

For instance, in a non-limiting example, persistent low bandwidth over multiple iterations for a specific node, such as node “E”, may indicate a chronic performance issue. Such persistent underperformance may indicate to a user that node “E” may need to be repaired. In other words, node “E” may be experiencing an issue with its corresponding graphics processing unit (GPU).

It shall be recognized that, in one or more embodiments, an isolated instance of poor node performance during a single iteration for a specific node may not necessitate repair, as a transient anomaly is likely occurring rather than a systemic issue. For example, node “B” may exhibit a single low bandwidth value during one iteration, as indicated by a distinct color in the heatmap or matrix, but consistently perform within acceptable ranges across all other iterations, indicating that the anomaly is temporary and does not impact the overall performance of the respective compute environment.

Accordingly, in one or more embodiments, the node-level performance assessment artifact may allow a user to quickly identify which node, among a plurality of nodes of the respective compute environment, requires attention or repair to increase the PoP score computed for the respective compute environment. Stated another way, the node-level performance assessment artifact may ensure that a user can efficiently focus on the specific node requiring attention, avoiding unnecessary effort on nodes that will not increase the computed PoP score.

Additionally, or alternatively, in one or more embodiments, generating the one or more explainability artifacts may include automatically generating a pod-level performance assessment artifact that graphically represents pod performance metrics for a plurality of distinct pods of the AI compute system. It shall be recognized that a graphical user interface may function to display the pod-level performance assessment artifact and each distinct pod of the plurality of distinct pods includes a plurality of distinct AI compute nodes.

In one or more embodiments, the system or service implementing method 200 may function to receive, via the graphical user interface, an input from a subscribing entity (e.g., user, subscriber, etc.) selecting a graphical region of the pod-level performance assessment artifact that corresponds to a target pod of the plurality of distinct pods, as shown generally by way of example in FIG. 10. In one or more embodiments, in response to receiving the input selecting the graphical region corresponding to the target pod, the system or service implementing method 200 may function to (i) obtain, from the compute infrastructure data, the respective compute node identifier of each AI compute node of the plurality of distinct AI compute nodes included in the target pod in real-time or near real-time, (ii) obtain, using the respective compute node identifier corresponding to each AI compute node of the plurality of distinct AI compute nodes included in the target pod, node-level performance metrics associated with each AI compute node included in the target pod, (iii) dynamically generate, using the node-level performance metrics, a node-level assessment artifact that graphically represents the node-level performance metrics associated with the plurality of distinct AI compute nodes included in the target pod, and (iv) update the graphical user interface from displaying the pod-level performance assessment artifact to displaying the node-level assessment artifact.

Accordingly, in one or more embodiments, while the system or service implementing method 200 is displaying the node-level assessment artifact on the graphical user interface, the system or service implementing method 200 may function to receive, via the graphical user interface, an input from the subscribing entity selecting a graphical region of the node-level assessment artifact that corresponds to a target AI compute node of the plurality of distinct AI compute nodes included in the target pod. In one or more embodiments, in response to receiving the input from the subscribing entity selecting the graphical region corresponding to the target AI compute node, the system or service implementing method 200 may function to (a) identify, based in part on the node-level performance metrics associated with the target AI compute node, a performance degradation condition (e.g., performance degradation characteristic or the like) associated with the target AI compute node in real-time or near real-time and (b) automatically execute, based on the performance degradation condition, a node repair action to resolve the performance degradation condition associated with the target AI compute node in real-time or near real-time.

A performance degradation condition, in some embodiments, may refer to any state, event, anomaly, or operational circumstance in which a performance characteristic of an AI compute node deviates from an expected, baseline, historical, or threshold level of operation. In some embodiments, the performance degradation condition may be determined based on one or more node-level performance metrics associated with the AI compute node, including, but not limited to, processor utilization metrics, accelerator utilization metrics, memory bandwidth metrics, memory capacity metrics, storage throughput metrics, input/output performance metrics, communication bandwidth metrics, latency metrics, error rate metrics, packet loss metrics, thermal metrics, power consumption metrics, or any combination thereof. In some embodiments, the performance degradation condition may correspond to a reduction in throughput, an increase in latency, an increase in error rates, a decrease in available bandwidth, an abnormal utilization pattern, or any other measurable deviation that negatively impacts the operational efficiency, responsiveness, stability, or computational capability of the AI compute node. In some embodiments, the performance degradation condition may be caused by hardware issues, software issues, configuration issues, communication link issues, environmental conditions, resource contention, or any other condition affecting operation of the AI compute node. For instance, in some embodiments, the performance degradation condition may be associated with a faulty or improperly seated cable, degraded network communication, memory bottlenecks, accelerator throttling, storage congestion, thermal throttling, driver faults, firmware issues, or workload imbalance.

Stated another way, in one or more embodiments, the system or service implementing method 200 may enable a subscribing entity to progressively drill down through multiple layers of performance visibility associated with the AI compute system. For example, the graphical user interface may initially present the pod-level performance assessment artifact to provide a high-level view of performance characteristics across a plurality of pods within the AI compute system. Upon receiving an input selecting a graphical region corresponding to a target pod in the pod-level performance assessment artifact, the system may dynamically transition to the node-level assessment artifact that provides a more granular representation of performance metrics associated with the individual AI compute nodes included in the selected pod. In this way, the system or service implementing method 200 may enable a subscribing entity to identify performance anomalies or inefficiencies within the AI compute system through an interactive exploration of increasingly granular performance artifacts. By enabling navigation from a pod-level representation to a node-level representation, the system or service implementing method 200 may assist users in quickly isolating specific AI compute nodes that contribute to observed performance degradations within the AI compute system. Furthermore, in one or more embodiments, when a target AI compute node (or a corresponding representation of the target AI compute node) is selected in the node-level assessment artifact, the system or service implementing method 200 may assess the node-level performance metrics associated with the selected AI compute node to determine whether a performance degradation condition exists. Such performance degradation conditions may include, but are not limited to, abnormal utilization levels, memory bottlenecks, network latency conditions, hardware faults, workload imbalances, or other conditions that negatively affect the compute performance of the AI compute system. Accordingly, in response to detecting the performance degradation condition, the system may automatically initiate a node repair action to restore or improve the performance of the target AI compute node. In some embodiments, the node repair action may include restarting one or more workloads executing on the target AI compute node, redistributing workloads to one or more alternate AI compute nodes, reallocating compute resources, resetting or reconfiguring one or more hardware or software components associated with the target AI compute node, or executing other corrective operations configured to mitigate the identified performance degradation condition. In this way, the system may enable near real-time identification and real-time remediation of performance issues within the AI compute system.

### Machine Learning-Based Generation of Percent of Potential Improvement Recommendations

In one or more embodiments, in response to generating one or more explainability artifacts, the system or service implementing method 200 may function to provide, as input, the compute infrastructure data corresponding to an AI compute system and a representation of the one or more explainability artifacts to a machine learning model (e.g., a neural network, a supervised machine learning model, an unsupervised machine learning model, a large language model, a recurrent neural network, a random forest machine learning model, a decision tree machine learning model, a k-means clustering machine learning model, etc.). In such an embodiment, the machine learning model may generate one or more percent of potential improvement recommendations based on the machine learning model assessing the compute infrastructure data and the representation of the one or more explainability artifacts. It shall be recognized that each percent of potential improvement recommendation may specify a distinct corrective action to mitigate a compute performance issue affecting at least one of the one or more AI compute nodes or the one or more pods included in the AI compute system. Accordingly, in such an embodiment, the system or service implementing method 200 may function to display, using a graphical user interface or the like, the one or more percent of potential improvement recommendations generated for the AI compute system in association with the one or more explainability artifacts and the percent of potential value computed for the AI compute system.

In one or more embodiments, the machine learning model used to generate the percent of potential improvement recommendations may be trained using a training data corpus derived from historical compute infrastructure data associated with a plurality of distinct AI compute systems. The training data corpus may include a plurality of distinct training data samples (e.g., 10,000 training data samples, 300,000 training data samples, etc.). Each training data sample of the plurality of distinct training data samples may include compute infrastructure data associated with a distinct AI compute system, a representation of one or more explainability artifacts generated for the distinct AI compute system, and one or more percent of potential (PoP) improvement recommendations corresponding to corrective actions that mitigated compute performance issues affecting the distinct AI compute system. Stated another way, each training data sample may include compute infrastructure data and representations of explainability artifacts describing an operational state of a respective AI compute system and one or more (e.g., labeled) percent of potential (PoP) improvement recommendations corresponding to corrective actions that improved compute performance of the respective AI compute system.

Accordingly, in one or more embodiments, the compute infrastructure data and the representations of the one or more explainability artifacts included in each training data sample may define input features provided to the machine learning model during training. The input features may include node availability values, CPU and GPU utilization metrics, memory utilization values, network bandwidth measurements, latency measurements, networking topology parameters, firmware configuration data, workload scheduling parameters, and historical compute performance metrics associated with the respective AI compute system. Additionally, the representations of the one or more explainability artifacts may include feature representations derived from node-level bandwidth artifacts, pod-level performance artifacts, node health indicators, and other graphical or textual artifacts identifying performance-limiting (e.g., defective) compute nodes, pods, or networking components within the AI compute system. Furthermore, the one or more percent of potential (PoP) improvement recommendations included in each training data sample may define output features used to train the machine learning model. The output features may correspond to corrective actions or labels associated with improving compute performance of the respective AI compute system. Stated another way, the machine learning model may be trained to learn associations between compute infrastructure conditions and explainability artifact representations of a respective AI compute system and corresponding percent of potential (PoP) improvement recommendations that specify corrective actions predicted to improve compute performance of the respective AI compute system.

Accordingly, in one or more embodiments, in response to sourcing or obtaining the training data corpus, the system or service implementing method 200 may function to train a target machine learning model (e.g., a neural network, a supervised machine learning model, an unsupervised machine learning model, a large language model, a recurrent neural network, a random forest machine learning model, a decision tree machine learning model, a k-means clustering machine learning model, etc.) using the training data corpus.

It shall be recognized that, in some embodiments, the system or service implementing method 200 may function to generate one or more percent of potential improvement recommendations using non-machine-learning-based techniques. For instance, in a non-limiting example, the system or service implementing method 200 may function to provide the compute infrastructure data and the one or more explainability artifacts as input to an analytical model and, in turn, the analytical model may function to automatically generate one or more percent of potential improvement recommendations for the AI compute system based on assessment of the compute infrastructure data and the one or more explainability artifacts. The analytical model, in one or more embodiments, may correspond to a Markov model, a rule-based analytical model, a probabilistic state-transition model, or another statistical or deterministic analytical model. The analytical model, in some embodiments, may be configured to assess relationships between compute infrastructure data, current compute performance data, maximum compute performance, and/or corrective actions associated with improving compute performance of the AI compute system.

### Exemplary Percent of Potential Improvement Recommendations

In one or more embodiments, the system or service implementing method 200 may function to assess compute infrastructure data and representations of the one or more explainability artifacts to identify performance degradation conditions affecting one or more AI compute nodes and/or one or more pods within the AI compute system. In response to detecting a performance degradation condition, the system or service implementing method 200 may function to automatically generate a percent of potential improvement recommendation that specifies a corrective action for mitigating the detected performance degradation condition. The corrective action may include one or more physical remediation actions or programmatic remediation actions capable of being performed by the AI compute system, the system or service implementing method 200, or a user. For instance, in a non-limiting example, the corrective action may specify cleaning or reseating networking cables, replacing defective cables or connectors, reseating or replacing network interface cards, reseating accelerator cards or memory modules, updating firmware, updating device drivers, updating operating system components, modifying workload scheduling parameters, redistributing workloads across compute nodes, reconfiguring network routing settings, modifying network topology configurations, adjusting bandwidth allocation policies, rebalancing storage or memory resources, restarting or reinitializing one or more compute nodes or services, modifying orchestration parameters, correcting configuration mismatches across compute nodes, or performing other infrastructure adjustments that improve compute performance of the AI compute system.

In one or more embodiments, in response to generating the one or more explainability artifacts, the system or service implementing method 200 may function to automatically assess, in real-time or near real-time, the one or more explainability artifacts associated with the AI compute system and/or the compute infrastructure data associated with the AI compute system. In such an embodiment, the system or service implementing method 200 may function to detect, based on the assessment, that a bandwidth value associated with a respective AI compute node of the AI compute system is below a predetermined minimum bandwidth threshold for a plurality of distinct (e.g., test) iterations. Furthermore, in response to detecting that the bandwidth value associated with the respective AI compute node is below the predetermined minimum bandwidth threshold, the system or service implementing method 200 may function to automatically generate, in real-time or near real-time, a percent of potential improvement recommendation that (i) indicates a persistent bandwidth degradation affecting (or associated with) the respective AI compute node and (ii) proposes removing dust accumulated on a cable coupled to the respective AI compute node to resolve the persistent bandwidth degradation. Accordingly, in such an embodiment, S250 may function to remove, based on the generated percent of potential improvement recommendation, the dust accumulated on the cable to resolve the persistent bandwidth degradation detected at the respective AI compute node.

Stated differently, in one or more embodiments, the system or service implementing method 200 may determine, based on the compute infrastructure data and the one or more explainability artifacts, that the respective AI compute node repeatedly exhibits bandwidth values below the predetermined minimum bandwidth threshold during the plurality of test iterations. Such repeated sub-threshold bandwidth measurements may indicate a persistent bandwidth degradation condition affecting the respective AI compute node. In response, the system or service implementing method 200 may generate a percent of potential improvement recommendation identifying the persistent bandwidth degradation and recommending removal of dust accumulated on the cable coupled to the respective AI compute node. Upon implementing the recommended corrective action, the system or service implementing method 200 may remove the accumulated dust from the cable to restore proper signal transmission and improve bandwidth performance of the respective AI compute node.

It shall be recognized that, in one or more embodiments, the corrective action specified by the percent of potential (PoP) improvement recommendation may be implemented automatically by the system or service implementing method 200 in real-time or near real-time. For example, the system or service may automatically initiate a remediation procedure that removes dust accumulated on the cable coupled to the respective AI compute node using one or more automated maintenance mechanisms or service components. Additionally, or alternatively, the percent of potential improvement recommendation may be surfaced to a user (e.g., a human administrator, technician, or operator) via the graphical user interface, and the user may perform the recommended corrective action by removing the dust accumulated on the cable coupled to the respective AI compute node. Accordingly, in some embodiments, remediation of the persistent bandwidth degradation may be performed autonomously by the system or service implementing method 200 or manually by a user in response to the percent of potential improvement recommendation.

Additionally, or alternatively, in one or more embodiments, in response to generating the one or more explainability artifacts, the system or service implementing method 200 may function to automatically assess, in real-time or near real-time, the one or more explainability artifacts associated with the AI compute system and/or the compute infrastructure data associated with the AI compute system. In such an embodiment, the system or service implementing method 200 may function to detect, based on the assessment, that (i) a first bandwidth value observed during a first test iteration of a respective AI compute node of the one or more AI compute nodes is below a predetermined minimum bandwidth threshold and (ii) a second bandwidth value observed during a second test iteration of the respective AI compute node satisfies the predetermined minimum bandwidth threshold. Furthermore, in response to detecting that the first bandwidth value observed during the first test iteration is below the predetermined minimum bandwidth threshold and the second bandwidth value observed during the second test iteration satisfies the predetermined minimum bandwidth threshold, the system or service implementing method 200 may function to automatically generate a percent of potential improvement recommendation that specifies an intermittent bandwidth degradation associated with a cable coupled to the respective AI compute node and proposes reseating the cable (e.g., InfiniBand cable, fiberoptic cable, etc.) to resolve the intermittent bandwidth degradation. Accordingly, in such an embodiment, S250 may function to reseat, based on the generated percent of potential improvement recommendation, the cable to resolve the intermittent bandwidth degradation associated with the respective AI compute node.

Stated differently, in one or more embodiments, the system or service implementing method 200 may determine, based on the compute infrastructure data and the one or more explainability artifacts, that bandwidth measurements associated with the respective AI compute node fluctuate across a plurality of iterations such that at least one bandwidth value falls below the predetermined minimum bandwidth threshold while another bandwidth value satisfies the predetermined minimum bandwidth threshold. Such fluctuating bandwidth measurements may indicate an intermittent bandwidth degradation affecting the respective AI compute node. In response to identifying the intermittent bandwidth degradation, the system or service implementing method 200 may generate the percent of potential improvement recommendation indicating that the cable coupled to the respective AI compute node is improperly seated and recommend reseating the cable to improve signal transmission and restore stable bandwidth performance for the respective AI compute node.

It shall be recognized that, in one or more embodiments, the corrective action specified by the percent of potential (PoP) improvement recommendation may be implemented automatically by the system or service implementing method 200 in real-time or near real-time. For example, the system or service may automatically initiate a remediation procedure that reseats the cable coupled to the respective AI compute node using one or more automated maintenance mechanisms or service components. Additionally, or alternatively, the percent of potential improvement recommendation may be surfaced to a user (e.g., a human administrator, technician, or operator) via the graphical user interface, and the user may perform the recommended corrective action by reseating the cable coupled to the respective AI compute node. Accordingly, in some embodiments, remediation of the intermittent bandwidth degradation may be performed autonomously by the system or service implementing method 200 or manually by a user in response to the percent of potential improvement recommendation.

Additionally, or alternatively, in one or more embodiments, in response to generating the one or more explainability artifacts, the system or service implementing method 200 may function to automatically assess, in real-time or near real-time, the one or more explainability artifacts associated with the AI compute system and/or the compute infrastructure data associated with the AI compute system. In such an embodiment, the system or service implementing method 200 may function to detect, based on the assessment, that firmware installed on the one or more AI compute nodes deviates from an expected firmware version specified in a compute architecture object corresponding to the AI compute system. The compute architecture object corresponding to the AI compute system may define one or more expected compute infrastructure configuration parameters for the AI compute system, including expected firmware versions associated with one or more hardware components of the AI compute system. Furthermore, in such an embodiment, in response to detecting that the firmware deviates from the expected firmware version, the system or service implementing method 200 may function to automatically generate a percent of potential improvement recommendation that specifies updating the firmware installed on the one or more AI compute nodes to conform to the expected firmware version. Accordingly, in such an embodiment, the system or service implementing method 200 may function to automatically update, based on the generated percent of potential improvement recommendation, the firmware installed on the one or more AI compute nodes to conform to the expected firmware version.

Stated another way, in one or more embodiments, the system or service implementing method 200 may determine, based on the compute infrastructure data and the one or more explainability artifacts, that firmware installed on one or more AI compute nodes does not match the expected firmware version specified in the compute architecture object corresponding to the AI compute system. Such a firmware mismatch may indicate a configuration deviation affecting performance or stability of the AI compute system. In response to identifying the firmware mismatch, the system or service implementing method 200 may generate the percent of potential improvement recommendation indicating that the firmware installed on the one or more AI compute nodes should be updated to conform to the expected firmware version defined by the compute architecture object. Accordingly, in some embodiments, the system or service implementing method 200 may automatically install or update the firmware on the one or more AI compute nodes to conform to the expected firmware version in real-time or near real-time, or the percent of potential improvement recommendation may be surfaced to a user (e.g., a human administrator, technician, or operator) that may perform the recommended firmware installation or update.

It shall be recognized that, in one or more embodiments, before generating the one or more explainability artifacts, the system or service implementing method 200 may function to automatically detect, based on the compute infrastructure data and the current compute performance of the AI compute system, that a respective pod of the AI compute system is operating below a predetermined pod-level performance threshold. Accordingly, in such an embodiment, in response to detecting that the respective pod is operating below the predetermined pod-level performance threshold, S250 may function to automatically identify, using the compute infrastructure data and the current compute performance of the AI compute system, at least one AI compute node within the respective pod causing the respective pod to operate below the predetermined pod-level performance threshold. Stated another way, in one or more embodiments, the system or service implementing method 200 may perform a multi-stage assessment in which the system first detects that a respective pod of the AI compute system is operating below the predetermined pod-level performance threshold and then identifies, based on node-level compute performance metrics associated with the respective pod, one or more AI compute nodes responsible for the degraded performance of the respective pod.

Accordingly, in such an embodiment, a first explainability artifact of the one or more explainability artifacts may graphically indicate the respective pod is operating below the predetermined pod-level performance threshold and a second explainability artifact of the one or more explainability artifacts may graphically indicate the at least one AI compute node of the respective pod causes the respective pod to operate below the predetermined pod-level performance threshold, as shown generally by way of example in FIGS. 9-11.

### PoP Time Series-Based Explainability Artifact

In one or more embodiments, after computing the percent of potential value for the AI compute system, the system or service implementing method 200 may function to automatically generate, based in part on the compute infrastructure data and the current compute performance of the AI compute system, a plurality of distinct recommendations configured to improve the compute performance of the AI compute system. In one or more embodiments, the system or service implementing method 200 may function to periodically monitor the AI compute system over a predetermined time. In such an embodiment, during the predetermined time span, the system or service implementing method 200 may function to (i) implement, over a plurality of distinct time intervals within the predetermined time span, the plurality of distinct recommendations within the AI compute system and (ii) automatically compute a plurality of subsequent percent of potential values for the AI compute system across the plurality of distinct time intervals.

Furthermore, in one or more embodiments, the system or service implementing method 200 may function to generate, using one or more processors, a first time-series artifact graphically representing a temporal progression of the plurality of subsequent percent of potential values across the plurality of distinct time intervals. Additionally, in such an embodiment, the system or service implementing method 200 may further function to generate, using the one or more processors, a second time-series artifact that superimposes the temporal progression of the plurality of subsequent percent of potential values with graphical indicators marking respective implementation times of the plurality of distinct recommendations within the predetermined time span. Accordingly, in one or more embodiments, in response to generating the first time-series artifact and the second time-series artifact, the system or service implementing method 200 may function to display the first time-series artifact and the second time-series artifact on the graphical user interface.

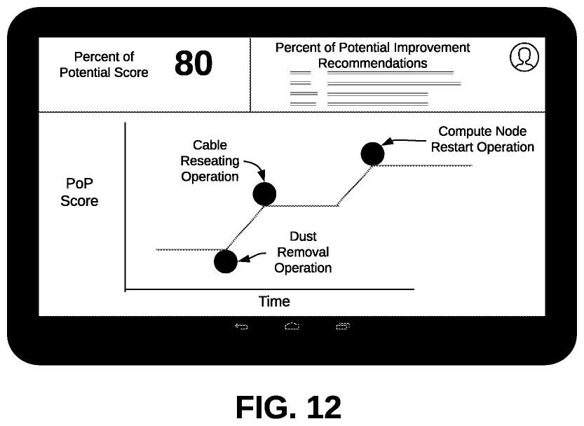

Stated differently, the system or service implementing method 200 may function to generate one or more explainability artifacts that enable users to visually evaluate how the compute performance of the AI compute system increases over time as different recommendations are implemented. By graphically surfacing the temporal progression of the percent of potential value alongside indicators identifying when specific recommendations were implemented, the system or service implementing method 200 may enable users to correlate implementation events with subsequent compute performance changes within the AI compute system. In this way, the generated time-series artifacts may provide an interpretable view of how particular infrastructure optimizations or configuration adjustments increase the compute performance of the AI compute system. In one or more embodiments, the graphical indicators included within the second time-series artifact may correspond to distinct categories of recommendations, such as hardware configuration adjustments, software adjustments, workload distribution modifications, resource allocation changes, scheduling optimizations, or other compute infrastructure improvements. Each graphical indicator may be positioned along the time-series representation at a time corresponding to when a respective recommendation was implemented, thereby enabling a user to quickly identify which changes to the AI compute system preceded observed improvements in the percent of potential value, as shown generally by way of example in FIG. 12.

Additionally, or alternatively, in one or more embodiments, the graphical user interface may further enable interactive exploration of the generated time-series artifacts. For example, a user may select or hover over a graphical indicator to view additional information describing the associated recommendation, an implementation timestamp, and one or more measured effects on compute performance metrics. In this way, the system may provide a transparent and interpretable mechanism for understanding how specific operational changes impact the performance characteristics of the AI compute system over time.

### Peer Explainability

In one or more embodiments, the system or service implementing method 200 may function to determine, based on the compute infrastructure data associated with the AI compute system, a compute architecture profile corresponding to the AI compute system. A compute architecture profile, in some embodiments, may refer to a structured representation describing one or more architectural characteristics of the AI compute system, including but not limited to hardware composition, compute node configurations, accelerator types, networking topology, memory resources, storage resources, and workload orchestration frameworks deployed within the AI compute system. The compute architecture profile, in one or more embodiments, may further specify relationships between components of the AI compute system, such as relationships between clusters, pods, compute nodes, accelerators, and associated networking infrastructure. For example, the compute architecture profile may define how a plurality of AI compute nodes are logically grouped into pods or clusters, the types of graphics processing units (GPUs), tensor processing units (TPUs), or other accelerators associated with each node, as well as bandwidth and latency characteristics of interconnects linking the nodes. The compute architecture profile, in one or more embodiments, may additionally include configuration parameters associated with software layers operating within the AI compute system. Such configuration parameters may include container orchestration configurations, workload scheduling policies, distributed training frameworks, virtualization layers, and resource allocation policies that influence how AI workloads are executed across the compute infrastructure.

In one or more embodiments, in response to the system or service implementing method 200 determining the compute architecture profile corresponding to the AI compute system, the system or service implementing method 200 may function to retrieve, from a peer performance repository, one or more peer percent of potential values that correspond to one or more peer AI compute systems having an architecture profile equivalent to the compute architecture profile determined for the AI compute system. A peer AI compute system, as generally referred to herein, may refer to an AI compute system operated by a third-party entity and possessing substantially similar architectural characteristics to the AI compute system, such as comparable compute node configurations, accelerator types, interconnect topology, memory configurations, storage resources, or workload orchestration frameworks. A peer percent of potential value, as generally referred to herein, may refer to a performance metric representing a measured or estimated level of compute efficiency achieved by a peer AI compute system relative to a theoretical or expected compute performance capacity associated with the peer AI compute system.

Accordingly, in one or more embodiments, in response to retrieving the one or more peer percent of potential values, the system or service implementing method 200 may function to display, via the graphical user interface, the one or more peer percent of potential values in association with the percent of potential value computed for the AI compute system and the one or more explainability artifacts. In this way, the one or more peer percent of potential values may function as benchmarking indicators that enable comparison between the compute performance of the AI compute system and compute performance achieved by similarly configured third-party AI compute systems.

For instance, in a non-limiting example, the system or service implementing method 200 may determine that the AI compute system is operating at a percent of potential value of approximately sixty-five percent based on the compute infrastructure data collected from the AI compute system. In response to determining the compute architecture profile corresponding to the AI compute system, the system may retrieve, from the peer performance repository, peer percent of potential values associated with one or more peer AI compute systems having equivalent or substantially similar architecture profiles. The retrieved peer percent of potential values may indicate that similarly configured third-party AI compute systems achieve percent of potential values of approximately eighty percent or higher.

In such a non-limiting example, the graphical user interface may display the percent of potential value associated with the AI compute system alongside the retrieved peer percent of potential values and the one or more explainability artifacts. The one or more explainability artifacts may graphically identify one or more factors contributing to the difference between the compute performance of the AI compute system and the compute performance observed in the peer AI compute systems. In one or more embodiments, the system or service implementing method 200 may further function to generate one or more recommendations (e.g., one or more PoP improvement recommendations) based on the identified differences. In this way, the surfacing of the peer percent of potential values in association with the one or more explainability artifacts may provide the subscribing entity with contextualized performance insights that enable the subscribing entity to understand how the AI compute system performs relative to similarly configured AI compute systems and to identify opportunities for improving compute efficiency.

### 3.0 Computer-Implemented Method and Computer Program Product

Embodiments of the system and/or method can include every combination and permutation of the various system components and the various method processes, wherein one or more instances of the method and/or processes described herein can be performed in real-time or near real-time, asynchronously (e.g., sequentially), concurrently (e.g., in parallel), or in any other suitable order by and/or using one or more instances of the systems, elements, and/or entities described herein.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processors and/or the controllers. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although omitted for conciseness, the embodiments include every combination and permutation of the implementations of the systems and methods described herein. Furthermore, each method step, process step, or the like described herein may be performed in real-time or near real-time. It shall be noted that “real-time” or “near real-time” as generally used herein may refer to generating an output or performing an action within strict time constraints. For example, in one or more embodiments, real-time may be understood to be instantaneous, on the order of milliseconds, or on the order of minutes. Of course, depending on the particular temporal nature of the system in which an embodiment is implemented, other appropriate timescales may be considered acceptable for real-time or near real-time processing.

As a person skilled in the art will recognize from the previous detailed description and from the figures and claims, modifications and changes can be made to the preferred embodiments of the invention without departing from the scope of this invention defined in the following claims.

We claim:

1. A computer-implemented method for real-time assessment and performance optimization of artificial intelligence (AI) compute infrastructure, the computer-implemented method comprising:
receiving, via a computer network, a request to assess compute performance of an AI compute system that executes AI workloads for a subscribing entity;
obtaining, in response to receiving the request, compute infrastructure data associated with the AI compute system, wherein the compute infrastructure data includes at least:
a corpus of compute node identifiers that includes a respective compute node identifier for each AI compute node of the AI compute system;
in response to obtaining the compute infrastructure data associated with the AI compute system:
automatically computing, using the compute infrastructure data, a maximum compute performance obtainable by the AI compute system;
automatically executing, using one or more processors, one or more compute performance tests on the AI compute system to determine a current compute performance of the AI compute system; and
automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system;
automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein:
the percent of potential value computed for the AI compute system indicates a degree to which the AI compute system is operating below the maximum compute performance obtainable by the AI compute system; and
generating, in response to computing the percent of potential value, one or more explainability artifacts that graphically identify one or more AI compute nodes or one or more pods within the AI compute system that cause the AI compute system to operate below the maximum compute performance; and
displaying, via a graphical user interface, the percent of potential value computed for the AI compute system in association with the one or more explainability artifacts.

2. The computer-implemented method according to claim 1, wherein computing the percent of potential value for the AI compute system includes:
computing an AI node availability value of the AI compute system based on a ratio between the total number of AI compute nodes online in the AI compute system and the total number of AI compute nodes included in the AI compute system,
computing a compute utilization value of the AI compute system based on a ratio between the current compute performance of the AI compute system and the maximum compute performance obtainable by the AI compute system, and
computing the percent of potential value for the AI compute system based on a product of the AI node availability value and the compute utilization value.

3. The computer-implemented method according to claim 1, wherein:
the maximum compute performance obtainable by the AI compute system includes a maximum bandwidth capacity obtainable by the AI compute system,
the current compute performance of the AI compute system includes a current bandwidth capacity of the AI compute system, and
wherein computing the percent of potential value for the AI compute system includes:
computing an AI node availability value of the AI compute system based on a ratio between the total number of AI compute nodes online in the AI compute system and the total number of AI compute nodes included in the AI compute system,
computing a bandwidth efficacy value of the AI compute system based on a ratio between the current bandwidth capacity of the AI compute system and the maximum bandwidth capacity obtainable by the AI compute system, and
computing the percent of potential value for the AI compute system based on a product of the AI node availability value and the bandwidth efficacy value.

4. The computer-implemented method according to claim 1, wherein:
the maximum compute performance obtainable by the AI compute system includes a maximum parallel floating-point operations per second (FLOPS) value expected by the AI compute system,
the current compute performance of the AI compute system includes a current parallel FLOPS value measured for the AI compute system, and
wherein computing the percent of potential value for the AI compute system includes:
computing an AI node availability value of the AI compute system based on a ratio between the total number of AI compute nodes online in the AI compute system and the total number of AI compute nodes included in the AI compute system,
computing a FLOPS efficacy value of the AI compute system based on a ratio between the current parallel FLOPS value measured for the AI compute system and the maximum FLOPS value expected by the AI compute system, and
computing the percent of potential value for the AI compute system based on a product of the AI node availability value and the FLOPS efficacy value.

5. The computer-implemented method according to claim 1, further comprising:
in response to generating the one or more explainability artifacts:
providing the compute infrastructure data and a representation of the one or more explainability artifacts as input to a machine learning model;
generating, using the machine learning model, one or more percent of potential improvement recommendations based on the machine learning model assessing the compute infrastructure data and the representation of the one or more explainability artifacts, wherein:
each percent of potential improvement recommendation specifies a distinct corrective action to mitigate a compute performance issue affecting at least one of the one or more AI compute nodes or the one or more pods; and
displaying, via the graphical user interface, the one or more percent of potential improvement recommendations generated for the AI compute system in association with the one or more explainability artifacts and the percent of potential value.

6. The computer-implemented method according to claim 5, wherein:
the current compute performance of the AI compute system specifies a current job throughput performance of the AI compute system, and
the computer-implemented method further comprises:
computing, based in part on the current job throughput performance of the AI compute system, a first time duration required to complete a target set of AI workloads;
computing, using the one or more processors, a projected job throughput performance of the AI compute system expected from implementation of the one or more percent of potential improvement recommendations within the AI compute system;
computing, based in part on the projected job throughput performance of the AI compute system, a second time duration required to complete the target set of AI workloads;
generating, by the one or processors, a comparative throughput artifact that graphically depicts:
the target set of AI workloads completed in the first time duration based on the current job throughput performance of the AI compute system, and
the target set of AI workloads completed in the second time duration based on the projected job throughput performance of the AI compute system; and
displaying, via the graphical user interface, the comparative throughput artifact in association with the percent of potential value computed for the AI compute system and the one or more percent of potential improvement recommendations.

7. The computer-implemented method according to claim 1, further comprising:
in response to generating the one or more explainability artifacts, automatically assessing, by the one or more processors, the one or more explainability artifacts;
detecting, based on the assessment of the one or more explainability artifacts, that a bandwidth value associated with a respective AI compute node of the one or more AI compute nodes is below a predetermined minimum bandwidth threshold for a plurality of distinct test iterations;
in response to detecting that the bandwidth value associated with the respective AI compute node is below the predetermined minimum bandwidth threshold, automatically generating a percent of potential improvement recommendation that (i) indicates a persistent bandwidth degradation affecting the respective AI compute node and (ii) proposes removing dust accumulated on a cable coupled to the respective AI compute node to resolve the persistent bandwidth degradation; and
removing, based on the generated percent of potential improvement recommendation, the dust accumulated on the cable to resolve the persistent bandwidth degradation detected at the respective AI compute node.

8. The computer-implemented method according to claim 1, further comprising:
in response to generating the one or more explainability artifacts, automatically assessing, by the one or more processors, the one or more explainability artifacts;
detecting, based on the assessment of the one or more explainability artifacts, that:
a first bandwidth value observed during a first test iteration of a respective AI compute node of the one or more AI compute nodes is below a predetermined minimum bandwidth threshold, and
a second bandwidth value observed during a second test iteration of the respective AI compute node satisfies the predetermined minimum bandwidth threshold;
in response to detecting that the first bandwidth value observed during the first test iteration is below the predetermined minimum bandwidth threshold and the second bandwidth value observed during the second test iteration satisfies the predetermined minimum bandwidth threshold, automatically generating a percent of potential improvement recommendation that specifies an intermittent bandwidth degradation associated with the respective AI compute node and proposes reseating a cable coupled to the respective AI compute node to resolve the intermittent bandwidth degradation; and
reseating, based on the generated percent of potential improvement recommendation, the cable to resolve the intermittent bandwidth degradation associated with the respective AI compute node.

9. The computer-implemented method according to claim 1, further comprising:
in response to generating the one or more explainability artifacts, automatically assessing, by the one or more processors, the one or more explainability artifacts and the compute infrastructure data;
detecting, based on the assessment of the one or more explainability artifacts and the compute infrastructure data, that firmware installed on the one or more AI compute nodes deviates from an expected firmware version specified in a compute architecture object corresponding to the AI compute system;
in response to detecting that the firmware deviates from the expected firmware version, automatically generating a percent of potential improvement recommendation that specifies updating the firmware installed on the one or more AI compute nodes to conform to the expected firmware version; and
automatically updating, based on the generated percent of potential improvement recommendation, the firmware installed on the one or more AI compute nodes to conform to the expected firmware version.

10. The computer-implemented method according to claim 1, further comprising:
before generating the one or more explainability artifacts:
automatically detecting, based on the compute infrastructure data and the current compute performance of the AI compute system, that a respective pod of the one or more pods is operating below a predetermined pod-level performance threshold; and
in response to detecting that the respective pod is operating below the predetermined pod-level performance threshold, automatically identifying, using the compute infrastructure data and the current compute performance of the AI compute system, at least one AI compute node within the respective pod causing the respective pod to operate below the predetermined pod-level performance threshold.

11. The computer-implemented method according to claim 10, wherein:
a first explainability artifact of the one or more explainability artifacts graphically indicates the respective pod is operating below the predetermined pod-level performance threshold; and
a second explainability artifact of the one or more explainability artifacts graphically indicates the at least one AI compute node of the respective pod causes the respective pod to operate below the predetermined pod-level performance threshold.

12. The computer-implemented method according to claim 1, wherein:
the AI compute system corresponds to an AI data center constructed at a target geographic location,
the AI data center includes a plurality of distinct AI compute nodes, wherein each AI compute node of the plurality of distinct AI compute nodes includes one or more central processing units, a plurality of graphics processing units, and memory, and
the AI data center further includes networking hardware that physically couples the plurality of distinct AI compute nodes to enable data communication between the plurality of distinct AI compute nodes.

13. The computer-implemented method according to claim 1, further comprising:
after computing the percent of potential value for the AI compute system, automatically generating, based in part on the compute infrastructure data and the current compute performance of the AI compute system, a plurality of distinct recommendations configured to improve the compute performance of the AI compute system;
periodically monitoring the AI compute system over a predetermined time span and during the predetermined time span:
implementing, over a plurality of distinct time intervals within the predetermined time span, the plurality of distinct recommendations within the AI compute system; and
automatically computing a plurality of subsequent percent of potential values for the AI compute system across the plurality of distinct time intervals;
generating, using the one or more processors, a first time-series artifact graphically representing a temporal progression of the plurality of subsequent percent of potential values across the plurality of distinct time intervals; and
generating, using the one or more processors, a second time-series artifact that superimposes the temporal progression of the plurality of subsequent percent of potential values with graphical indicators marking respective implementation times of the plurality of distinct recommendations within the predetermined time span; and
displaying, in response to generating the first time-series artifact and the second time-series artifact, the first time-series artifact and the second time-series artifact on the graphical user interface.

14. The computer-implemented method according to claim 1, wherein:
generating the one or more explainability artifacts includes automatically generating a pod-level performance assessment artifact that graphically represents pod performance metrics for a plurality of distinct pods of the AI compute system, wherein each distinct pod of the plurality of distinct pods includes a plurality of distinct AI compute nodes,
the graphical user interface displays the pod-level performance assessment artifact, and
the computer-implemented method further comprising:
receiving, via the graphical user interface, an input from the subscribing entity selecting a graphical region of the pod-level performance assessment artifact that corresponds to a target pod of the plurality of distinct pods;
in response to receiving the input selecting the graphical region corresponding to the target pod:
obtaining, in real-time or near real-time, the respective compute node identifier of each AI compute node of the plurality of distinct AI compute nodes included in the target pod;
obtaining, using the respective compute node identifier corresponding to each AI compute node of the plurality of distinct AI compute nodes included in the target pod, node-level performance metrics associated with each AI compute node included in the target pod;
dynamically generating, using the node-level performance metrics, a node-level assessment artifact that graphically represents the node-level performance metrics associated with the plurality of distinct AI compute nodes included in the target pod; and
updating the graphical user interface from displaying the pod-level performance assessment artifact to displaying the node-level assessment artifact; and
while displaying the node-level assessment artifact on the graphical user interface:
receiving, via the graphical user interface, an input from the subscribing entity selecting a graphical region of the node-level assessment artifact that corresponds to a target AI compute node of the plurality of distinct AI compute nodes included in the target pod; and
in response to receiving the input from the subscribing entity selecting the graphical region corresponding to the target AI compute node:
identifying, based in part on the node-level performance metrics associated with the target AI compute node, a performance degradation condition associated with the target AI compute node in real-time or near real-time, and
automatically executing, based on the performance degradation condition, a node repair action to resolve the performance degradation condition associated with the target AI compute node in real-time or near real-time.

15. The computer-implemented method according to claim 1, further comprising:
determining, based on the compute infrastructure data associated with the AI compute system, a compute architecture profile corresponding to the AI compute system;
retrieving, from a peer performance repository, one or more peer percent of potential values that correspond to one or more peer AI compute systems having an architecture profile equivalent to the compute architecture profile determined for the AI compute system; and
in response to retrieving the one or more peer percent of potential values, displaying, via the graphical user interface, the one or more peer percent of potential values in association with the percent of potential value computed for the AI compute system and the one or more explainability artifacts.

16. A computer-implemented system comprising:
one or more processors;
a memory;
a computer-readable medium operably coupled to the one or more processors, the computer-readable medium having computer-readable instructions stored thereon that, when executed by the one or more processors, cause a computing device to perform operations comprising:
receiving, via a computer network, a request to assess compute performance of an AI compute system that executes AI workloads for a subscribing entity;
obtaining, in response to receiving the request, compute infrastructure data associated with the AI compute system, wherein the compute infrastructure data includes at least:
a corpus of compute node identifiers that includes a respective compute node identifier for each AI compute node of the AI compute system;
in response to obtaining the compute infrastructure data associated with the AI compute system:
automatically computing, using the compute infrastructure data, a maximum compute performance obtainable by the AI compute system;
automatically executing, using the one or more processors, one or more compute performance tests on the AI compute system to determine a current compute performance of the AI compute system; and
automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system;
automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein:
the percent of potential value computed for the AI compute system indicates a degree to which the AI compute system is operating below the maximum compute performance obtainable by the AI compute system; and
generating, in response to computing the percent of potential value, one or more explainability artifacts that graphically identify one or more AI compute nodes or one or more pods within the AI compute system that cause the AI compute system to operate below the maximum compute performance; and
displaying, via a graphical user interface, the percent of potential value computed for the AI compute system in association with the one or more explainability artifacts.

17. The computer-implemented system according to claim 16, wherein computing the percent of potential value includes:
computing an AI node availability value of the AI compute system based on a ratio between the total number of AI compute nodes online in the AI compute system and the total number of AI compute nodes included in the AI compute system,
computing a compute utilization value of the AI compute system based on a ratio between the current compute performance of the AI compute system and the maximum compute performance obtainable by the AI compute system, and
computing the percent of potential value for the AI compute system by multiplying the AI node availability value by the compute utilization value.

18. A computer-program product comprising a non-transitory machine-readable storage medium storing computer instructions that, when executed by processing circuitry, perform operations comprising:
receiving, via a computer network, a request to assess compute performance of an AI compute system that executes AI workloads for a subscribing entity;
obtaining, in response to receiving the request, compute infrastructure data associated with the AI compute system, wherein the compute infrastructure data includes at least:
a corpus of compute node identifiers that includes a respective compute node identifier for each AI compute node of the AI compute system;
in response to obtaining the compute infrastructure data associated with the AI compute system:
automatically computing a maximum compute performance obtainable by the AI compute system;
automatically executing, using one or more processors, one or more compute performance tests on the AI compute system to determine a current compute performance of the AI compute system; and
automatically executing, based on providing the corpus of compute node identifiers to a node health computer program, an automated node health assessment that determines (i) a total number of AI compute nodes online in the AI compute system, (ii) a total number of AI compute nodes offline in the AI compute system, and (iii) a total number of AI compute nodes included in the AI compute system;
automatically computing, in real-time or near real-time, a percent of potential value for the AI compute system based in part on the total number of AI compute nodes online in the AI compute system, the total number of AI compute nodes included in the AI compute system, the current compute performance of the AI compute system, and the maximum compute performance obtainable by the AI compute system, wherein:
the percent of potential value computed for the AI compute system indicates a degree to which the AI compute system is operating below the maximum compute performance obtainable by the AI compute system; and
generating, in response to computing the percent of potential value, one or more explainability artifacts that graphically identify one or more AI compute nodes or one or more pods within the AI compute system that cause the AI compute system to operate below the maximum compute performance; and
displaying, via a graphical user interface, the percent of potential value computed for the AI compute system in association with the one or more explainability artifacts.

19. The computer-program product according to claim 18, wherein automatically computing the maximum compute performance obtainable by the AI compute system includes:
identifying, based on the compute infrastructure data associated with the AI compute system, a respective compute architecture profile corresponding to the AI compute system; and
retrieving, from a compute performance repository, a reference maximum compute performance value associated with the respective compute architecture profile based on querying the compute performance repository using the respective compute architecture profile as a search parameter; wherein:
the maximum compute performance obtainable by the AI compute system corresponds to the reference maximum compute performance value associated with the respective compute architecture profile.

20. The computer-program product according to claim 18, wherein the computer instructions, when executed by the processing circuitry, perform operations further comprising:
providing the compute infrastructure data and the one or more explainability artifacts as input to an analytical model;
automatically generating, using the analytical model, one or more percent of potential improvement recommendations for the AI compute system based on assessment of the compute infrastructure data and the one or more explainability artifacts; and
displaying, via the graphical user interface, the one or more percent of potential improvement recommendations in association with the percent of potential value computed for the AI compute system and the one or more explainability artifacts.
